(19) United States
(12) Patent Application Publication
(10) Pub. No.: US 2012/0029908 A1
(43) Pub. Date: Feb. 2, 2012

(54) INFORMATION PROCESSING DEVICE, RELATED SENTENCE PROVIDING METHOD, AND PROGRAM

(76) Inventor: Shingo TAKAMATSU, Tokyo (JP)

(21) Appl. No.: 13/187,256

(22) Filed: Jul. 20, 2011

(30) Foreign Application Priority Data
Jul. 27, 2010 (JP) P2010-168336

(51) Int. Cl. G06F 17/27

(52) U.S. Cl. 704/9

(57) ABSTRACT

There is provided an information processing device including an information providing unit that provides related information related to main information, a related sentence generation unit that generates a sentence indicating a relation between the main information and the related information and a related sentence providing unit that provides the sentence generated by the related sentence generation unit.

### BACKGROUND

The disclosure relates to an information processing device, a related sentence providing method, and a program.

Business using a network has been rapidly expanding in recent years. For example, systems to purchase products in online stores on a network are widely used today. Many of such online stores incorporate a mechanism for recommending a product to users. For example, when a user views detailed information of a certain product, information of a product related to that product is presented to the user as a related product or a recommended product. Such a mechanism is implemented using a collaborative filtering method disclosed in Japanese Unexamined Patent Publication No. 2003-167901, for example. The collaborative filtering method is a method that recommends a product using a purchase history of a user with similar preference or the like. Further, a content-based filtering method is also known that recommends a product using a purchase history of a user to whom recommendation is made or the like.

### SUMMARY

The use of the collaborative filtering method or the content-based filtering method enables recommendation of a product suitable for user preference. However, even when a product is recommended, a user is unable to clearly know the reason why the product is recommended. Therefore, when a product B is recommended at the time of purchase of a product A, it is difficult for a user to clearly know a relation between the product A and the product B. As a result, a user who has no knowledge about the product B is not likely to take interest in the product B which is recommended at the time of purchase of the product A. Note that, if a relation between an item as the impetus for recommendation and a recommended item, not limited to a product, is unknown, a user is not likely to take interest in the recommended item.

In light of the foregoing, it is desirable to provide novel and improved information processing device, related sentence providing method, and program capable of automatically generating a sentence indicating a relation between an item as the impetus for recommendation and a recommended item.

According to an embodiment of the present disclosure, there is provided a device which includes an information processing device including an information providing unit that provides related information related to main information, a related sentence generation unit that generates a sentence indicating a relation between the main information and the related information and a related sentence providing unit that provides the sentence generated by the related sentence generation unit.

The information processing device may further include a storage unit that stores a first database associating relation information indicating a relation between first information and second information, the first information, and the second information, and a second database associating the relation information and a sentence template. The related sentence generation unit extracts a first record where the first or second information matches the main information and the second or first information matches the related information from the first database, extracts a sentence template corresponding to the relation information contained in the first record from the second database, and generates a sentence indicating a relation between the main information and the related information by using the first and second information contained in the first record and the sentence template extracted from the second database.

The related sentence generation unit may extract a second record where the first or second information matches the main information and being different from the first record, and a third record where the first or second information matches the related information and being different from the first record, from the first database, when the second and third records are extracted, extracts a set of the second and third records where the second or first information contained in the second record and being different from the main information and the second or first information contained in the third record and being different from the related information match, extract a sentence template corresponding to the relation information contained in the second or third record forming the set of the second and third records from the second database, and generate a sentence indicating a relation between the main information and the related information by using the first and second information contained in the second or third record forming the set of the second and third records and the sentence template extracted from the second database.

The main information, the related information and the first and second information may be words. The relation information may be information indicating a relation between words, and the related sentence generation unit generates a sentence by applying a word of the main information and a word of the related information to a sentence template corresponding to the relation information.

The information processing device may further include a phrase acquisition unit that acquires a phrase contained in each sentence from a sentence set including a plurality of sentences, a phrase feature value determination unit that determines a phrase feature value indicating a feature value of each phrase acquired by the phrase acquisition unit, a clustering unit that clusters the phrase feature value determined by the phrase feature value determination unit according to a similarity between feature values and a relation information generation unit that extracts a relation between words contained in the sentence set using a result of clustering by the clustering unit, and generates relation information indicating a relation between a word of the first information and a word of the second information. The relation information generation unit stores the word of the first information, the word of the second information, and the relation information between the word of the first information and the word of the second information into the first database.

The information processing device may further include a phrase acquisition unit that acquires a phrase contained in each sentence from a sentence set including a plurality of sentences, a phrase feature value determination unit that determines a phrase feature value indicating a feature value of each phrase acquired by the phrase acquisition unit, a set feature value determination unit that determines a set feature value indicating a feature of the sentence set, a compressed phrase feature value generation unit that generates a compressed phrase feature value with a lower dimension than the phrase feature value based on the phrase feature value determined by the phrase feature value determination unit and the set feature value determined by the set feature value determination unit, a clustering unit that clusters the compressed phrase feature value generated by the compressed phrase feature value generation unit according to a similarity between feature values and a relation information generation unit that extracts a relation between words contained in the sentence set using a result of clustering by the clustering unit, and generates relation information indicating a relation between a word of the first information and a word of the second information. The relation information generation unit stores the word of the first information, the word of the second information, and the relation information between the word of the first information and the word of the second information into the first database.

According to another embodiment of the present disclosure, there is provided a related sentence providing method which includes providing related information related to main information, generating a sentence indicating a relation between the main information and the related information; and providing the sentence.

According to another embodiment of the present disclosure, there is provided a program causing a computer to implement which includes an information providing function that provides related information related to main information, a related sentence generation function that generates a sentence indicating a relation between the main information and the related information and a related sentence providing function that provides the sentence generated by the related sentence generation function.

According to another embodiment of the present disclosure, there is provided a computer-readable recording medium in which the program is recorded.

According to the embodiments of the present disclosure described above, it is possible to automatically generate a sentence indicating a relation between an item as the impetus for recommendation and a recommended item.

### BRIEF DESCRIPTION OF THE DRAWINGS

FIG. 1 is an illustration to illustrate a functional configuration of an information processing device capable of implementing a method of extracting a relation between words;

FIG. 2 is an illustration to illustrate a method of acquiring a phrase by a data acquisition unit of the information processing device;

FIG. 3 is an illustration to illustrate a method of acquiring a phrase by a data acquisition unit of the information processing device;

FIG. 4 is an illustration to illustrate a flow of a data acquisition process by the data acquisition unit;

FIG. 5 is an illustration to illustrate a method of determining a phrase feature value by a phrase feature value determination unit of the information processing device;

FIG. 6 is an illustration to illustrate a flow of a phrase feature value determination process by the phrase feature value determination unit;

FIG. 7 is an illustration to illustrate a method of determining a set feature value by a set feature value determination unit of the information processing device;

FIG. 8 is an illustration to illustrate a flow of a set feature value determination process by the set feature value determination unit;

FIG. 9 is an illustration to illustrate a flow of a set feature value determination process by the set feature value determination unit;

FIG. 10 is an illustration to illustrate a method of compressing a phrase feature value by a compression unit of the information processing device;

FIG. 11 is an illustration to illustrate a method of compressing a phrase feature value by a compression unit of the information processing device;

FIG. 12 is an illustration showing a result of implementing a method of clustering a phrase by a clustering unit of the information processing device;

FIG. 13 is an illustration to illustrate a flow of a clustering process by the clustering unit;

FIG. 14 is an illustration to illustrate summary information created by a summarizing unit of the information processing device;

FIG. 15 is an illustration to illustrate a flow of a summary information creation process by the summarizing unit;

FIG. 16 is an illustration to illustrate a functional configuration of an information processing device according to one embodiment of the disclosure;

FIG. 17 is an illustration to illustrate a structure of a related information DB according to the embodiment;

FIG. 18 is an illustration to illustrate a method of searching for related information according to the embodiment;

FIG. 19 is an illustration to illustrate a structure of an entity DB according to the embodiment;

FIG. 20 is an illustration to illustrate a method of determining an entity label according to the embodiment;

FIG. 21 is an illustration to illustrate a method of determining an entity label according to the embodiment;

FIG. 22 is an illustration to illustrate a structure of a sentence template DB according to the embodiment;

FIG. 23 is an illustration to illustrate a method of generating a related information sentence according to the embodiment;

FIG. 24 is an illustration to illustrate a method of generating a related information sentence according to the embodiment;

FIG. 25 is an illustration to illustrate a specific operation of a related information search unit included in the information processing device according to the embodiment;

FIG. 26 is an illustration to illustrate a specific operation of an entity search unit included in the information processing device according to the embodiment;

FIG. 27 is an illustration to illustrate a specific operation of a related information sentence generation unit included in the information processing device according to the embodiment;

FIG. 28 is an illustration to illustrate a specific operation of a related information sentence generation unit included in the information processing device according to the embodiment;

FIG. 29 is an illustration showing an example of a related information sentence generated by a function of the information processing device according to the embodiment;

FIG. 30 is an illustration to showing an example of a related information sentence generated by a function of the information processing device according to the embodiment; and

FIG. 31 is an illustration to illustrate a hardware configuration of an information processing device capable of implementing a method of extracting a relation between words and a method of generating a related information sentence according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### [Flow of Description]

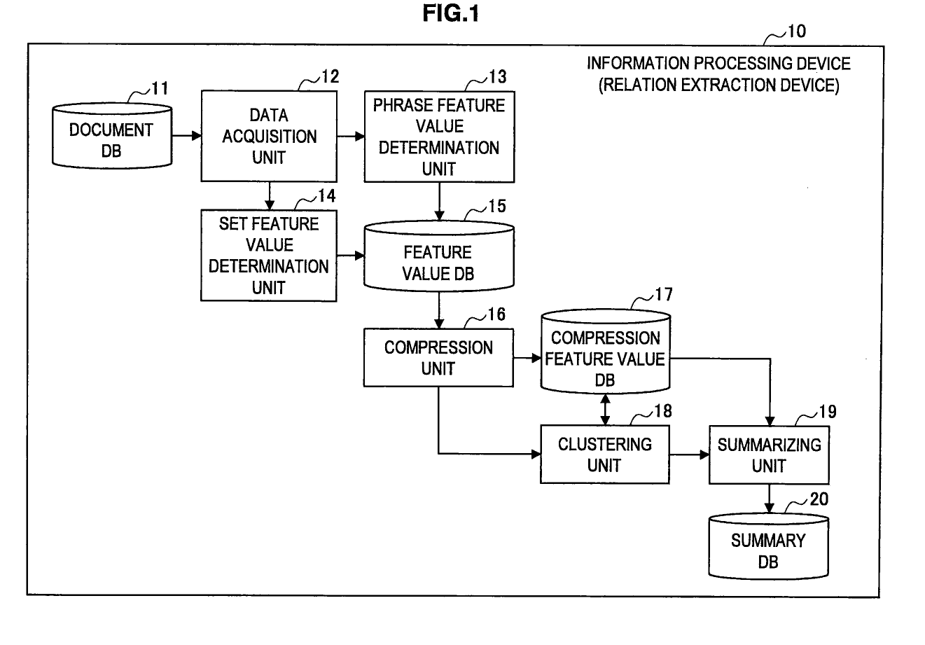

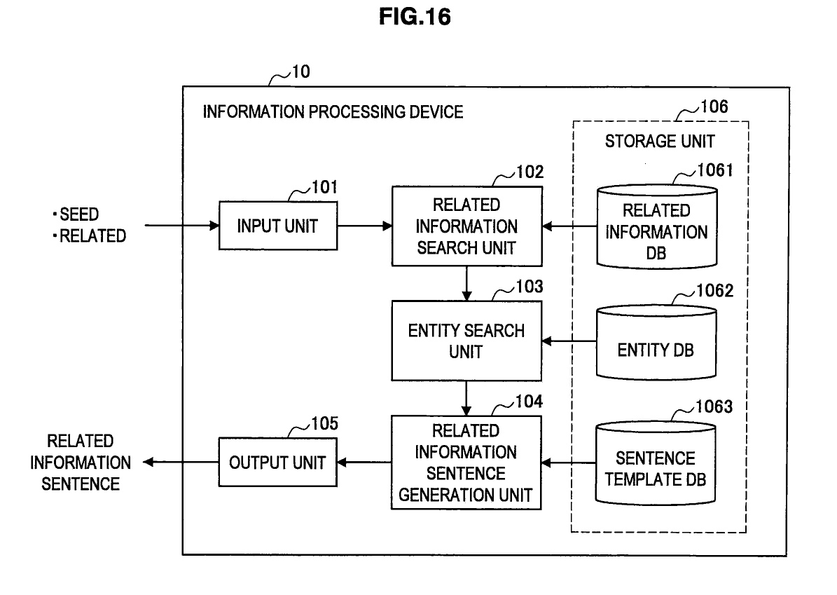

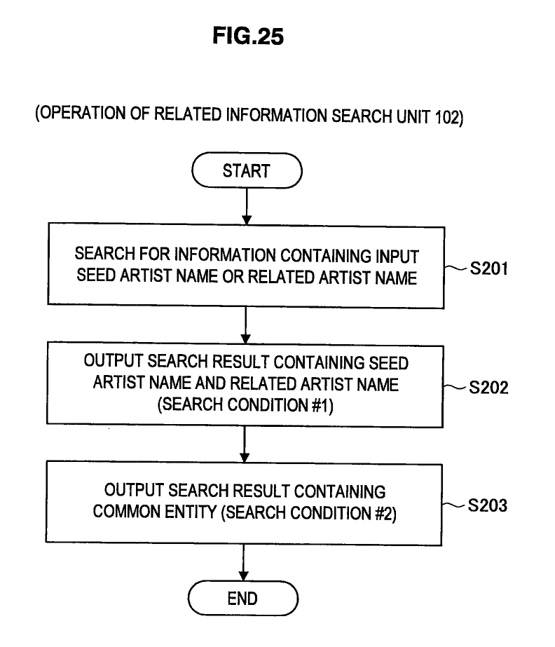

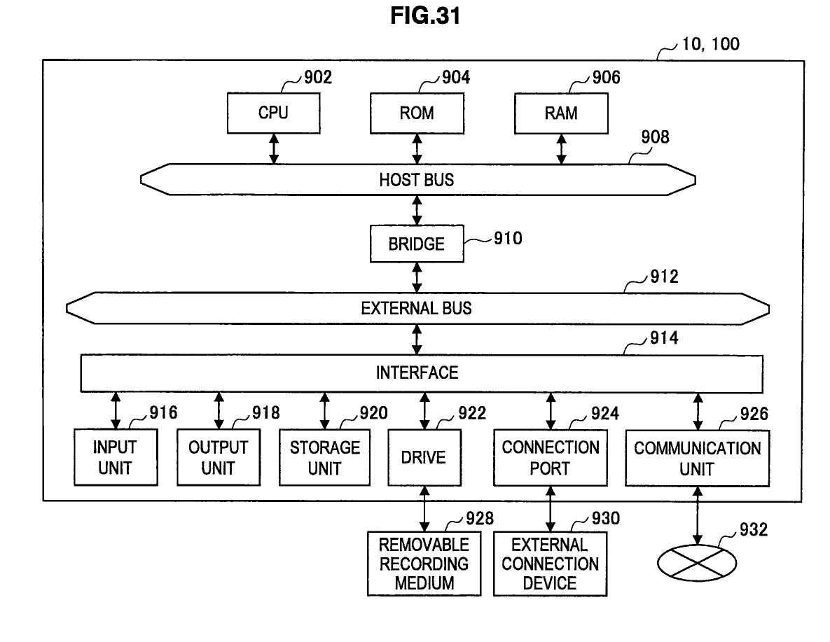

A flow of description according to an embodiment of the disclosure provided hereinbelow is briefly described. First, a functional configuration of an information processing device 10 capable of extracting a relation between words is described with reference to FIGS. 1 to 15. Next, a functional configuration of an information processing device 100 according to the embodiment is described with reference to FIGS. 16 to 24. Then, an operation of the information processing device 100 according to the embodiment is described with reference to FIGS. 25 to 30. After that, a hardware configuration capable of implementing functions of the information processing device 10, 100 is described with reference to FIG. 31. Finally, a technical idea of the embodiment is summarized, and advantages obtained from the technical idea are briefly described.

### (Description Items)

1: Introduction (Method of Extracting Relation between Words)
1-1: Overview
1-2: Functional Configuration of Information Processing Device 10

2: Embodiment
2-1: Functional Configuration of Information Processing Device 100
2-2: Operation of Information Processing Device 100

3: Hardware Configuration

4: Summary

### 1: Introduction

### Method of Extracting Relation between Words

An embodiment described later relates to a technique that, at the time of recommending an entity (which is referred to hereinafter as a related entity) that is related to an entity (hereinafter as a seed entity) that acts as a seed, automatically generates a sentence (hereinafter as a related information sentence) that describes a relation between the seed entity and the related entity. Note that the entity is a general expression of information about contents such as videos or music, or text such as Web pages or books. In the following description, a discussion is provided about a relation between words (proper nouns) for the sake of simplification. When generating a related information sentence, a relation between words is used. Thus, prior to describing a method of generating a related information sentence, a method of extracting a relation between words is described hereinafter.

### [1-1: Overview]

On the background that the information processing capacity of computers has been enhanced recently, a technique that statistically treats the semantic aspect of text is attracting attention. An example of the technique is a document classification technique that analyzes the contents of a document and classifies each document into various genres. Another example of the technique is a text mining technique that extracts useful information from a set of accumulated text such as Web pages of the Internet or records of questions and comments from customers in a corporation.

Note that there are often cases where different words or phrases are used in text when expressing one same or similar meaning. Hence, an attempt is made to identify text having a similar meaning by defining a vector space to represent a statistical feature of text in a statistical analysis of text and clustering the feature of each text in the vector space.

For example, an example of such an attempt is described in Alexander Yates and Oren Etzioni, “Unsupervised Methods for Determining Object and Relation Synonyms on the Web”, Journal of Artificial Intelligence Research (JAIR) 34, March, 2009, pp. 255-296 (which is referred to hereinafter as the literature A).

As the vector space to represent a statistical feature of text, a vector space in which each word contained in vocabularies that are likely to appear in text is placed as each component of the vector (the axis of the vector space), for example, is often used. However, while a technique of clustering feature values is effective in classification of a document that includes at least a plurality of sentences or the like, it is difficult to produce a significant effect when recognizing a synonymous or quasi-synonymous relationship of phrases. The principal reason for that is because a phrase contains only few words.

For example, a document such as a news article or a Web page introducing a person, a content or a product generally contains several tens to several hundreds of words. On the other hand, a phrase, which is a smaller unit than one sentence, generally contains only several words. Even a feature value of a document is likely to be a sparse vector (a vector in which most components are zero). Accordingly, a feature value of a phrase becomes a super-sparse vector, which is even sparser.

The super-sparse vector has an aspect that there is only a little information which can be used as a clue when recognizing a meaning. As a result, when performing clustering based on a similarity (e.g. a cosine distance etc.) between super-sparse vectors, for example, a problem occurs that two or more vectors which should semantically belong to one cluster are not clustered into one cluster. In view of this, a technique that compresses the dimension of a feature value of a document is under study. For example, a technique that compresses the dimension of a vector using a probabilistic technique such as SVD (Singular Value Decomposition), PLSA (Probabilistic Latent Semantic Analysis) or LDA (Latent Dirichlet Allocation) is known.

However, if such a probabilistic technique is simply applied to a feature value of a phrase, which is a super-sparse vector, the significance of data is lost in many cases, only to produce an output that is no longer suited to processing in the subsequent stage such as clustering. In light of such a point, the technique of the above-described literature A proposes to acquire a large-scale data set by collecting strings of the order of several hundreds from text on the Web for the purpose of obtaining the significance of a feature value for a short string. However, handling such a large-scale data set causes a problem of constraints on resources. Further, there are not a few cases where it is essentially unable to acquire a large-scale data set, such as when dealing in a target that belongs to the so-called long tail.

In view of the above, a technique that compresses the dimension of a feature value of a phrase as well as maintaining or improving the significance of the feature value and further makes it easier to recognize a synonymous or quasi-synonymous relationship at a phrase level is introduced below. Use of this technique makes it possible to extract words having a relation and extract a relation between words and a phrase representing a type of the relation based on a sufficiently large data set. Note that, in an embodiment described later, a technique is proposed that generates a related information sentence by using a combination of words having a relation or a phrase representing a type of a relation between the words which are extracted using the technique.

### [1-2: Functional Configuration of Information Processing Device 10]

A functional configuration of an information processing device 10 capable of extracting a relation between words based on a massive data set is described firstly with reference to FIGS. 1 to 15.

### (Overall Configuration)

Referring to FIG. 1, the information processing device 10 mainly includes a document DB 11, a data acquisition unit 12, a phrase feature value determination unit 13, a set feature value determination unit 14, a feature value DB 15, a compression unit 16, a compressed feature value DB 17, a clustering unit 18, a summarizing unit 19, and a summary DB 20. Note that DB stands for database. Further, the function of the information processing device 10 is implemented by a hardware configuration described later. Furthermore, among the elements constituting the information processing device 10, the document DB 11, the feature value DB 15, the compressed feature value DB 17 and the summary DB 20 are built using storage media such as hard disk or semiconductor memory. The storage media may be inside the information processing device 10 or outside the information processing device 10.

### (Document DB 11)

The document DB 11 is a database that stores a sentence set which includes a plurality of sentences in advance. The sentence set that is stored in the document DB 11 may be a set of documents such as news articles, electronic dictionaries or Web pages introducing persons, contents or products, for example. Further, the sentence set that is stored in the document DB 11 may be email messages, posts on electronic bulletin boards, a history of certain text input to a form on the Web or the like, for example. Furthermore, the sentence set that is stored in the document DB 11 may be a corpus as a collection of human speeches in text, for example. The document DB 11 outputs the stored sentence set to the data acquisition unit 12 in response to a request from the data acquisition unit 12.

### (Data Acquisition Unit 12)

The data acquisition unit 12 acquires the sentence set including a plurality of sentences from the document DB 11. Further, the data acquisition unit 12 acquires a plurality of phrases contained in the sentence set. Specifically, the data acquisition unit 12 extracts a pair of words both contained in one sentence of the sentence set and acquires a plurality of phrases respectively representing a relation between words of each extracted pair. The pair of words that is extracted from the sentence set by the data acquisition unit 12 may be an arbitrary pair of words. In the following description, a scenario is assumed in which the data acquisition unit 12 extracts a pair of proper nouns, particularly, and acquires phrases representing a relation between the proper nouns.

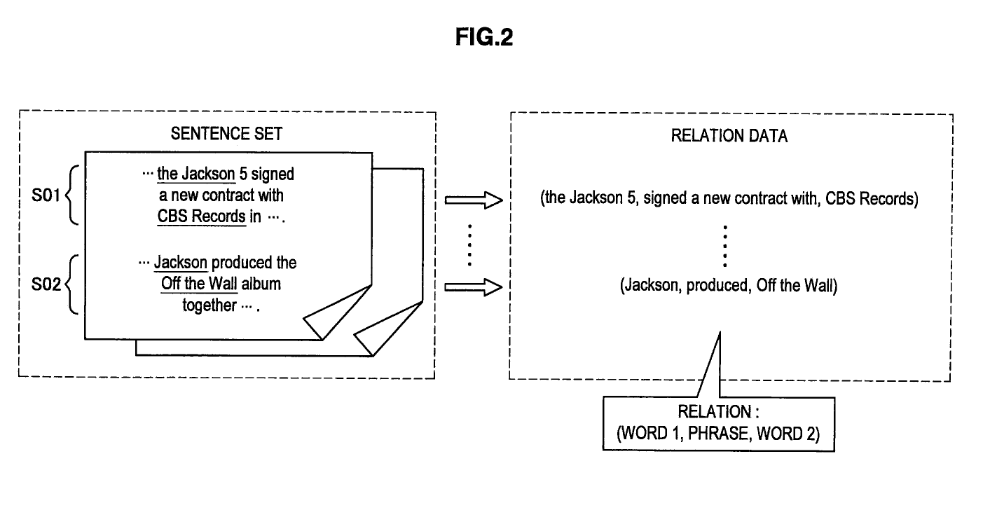

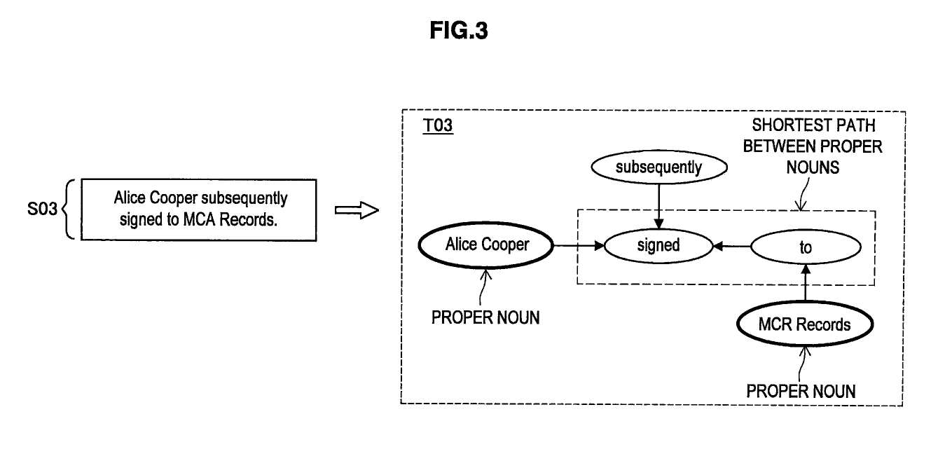

FIGS. 2 and 3 are illustrations to illustrate a method of acquiring a phrase from a sentence set by the data acquisition unit 12.

FIG. 2 shows an example of a sentence set acquired from the document DB 11. The sentence set contains a first sentence S01 and a second sentence S02, for example. The data acquisition unit 12 first recognizes each sentence in the sentence set and specifies a sentence where two or more proper nouns appear among the recognized sentences.

The discrimination of proper nouns may be made using a known named entity extraction technique, for example. For example, the first sentence S01 of FIG. 2 contains two proper nouns “Jackson 5” and “CBS Records”. Further, the second sentence S02 contains two proper nouns “Jackson” and “Off the Wall”.

Next, the data acquisition unit 12 performs syntactic analysis for each specified sentence and derives a syntactic tree. Then, the data acquisition unit 12 acquires a phrase to link the pair of two proper nouns in the derived syntactic tree. In the example of FIG. 2, a phrase to link “Jackson 5” and “CBS Records” of the first sentence S01 is “signed a new contract with”. On the other hand, a phrase to link “Jackson” and “Off the Wall” of the second sentence S02 is “produced”.

In this specification, a group of one pair of words and a phrase corresponding to the pair is referred to as a relation.

FIG. 3 shows an example of a syntactic tree derived by the data acquisition unit 12. In the example of FIG. 3, the data acquisition unit 12 derives a syntactic tree T03 by analyzing the syntax of a third sentence S03. The syntactic tree T03 has the shortest path “signed to” between two proper nouns “Alice Cooper” and “MCR Records”. The adverb “subsequently” is off the shortest path between the two proper nouns.

The data acquisition unit 12 extracts a pair of words that satisfy a prescribed extraction condition based on a result of such syntactic analysis and acquires a phrase only for the extracted pair. As the prescribed extraction condition, the following conditions E1 to E3 may be applied, for example.

(Condition E1) A node corresponding to a break of a sentence does not exit on the shortest path between proper nouns.

(Condition E2) The length of the shortest path between proper nouns is three nodes or less.

(Condition E3) The number of words between proper nouns in a sentence set is ten or less.

A break of a sentence in the condition 1 is a relative pronoun, a comma or the like, for example. These extraction conditions prevent the data acquisition unit 12 from improperly acquiring a string that is not appropriate as a phase representing a relation between two proper nouns.

Note that the operation to extract a phrase from a sentence set may be performed in advance in an external device of the information processing device 10. In this case, the data acquisition unit 12 acquires the phrase extracted in advance and the sentence set from which the phrase is extracted from the external device at the start of information processing by the information processing device 10. Further, a combination of a pair of proper nouns and a phrase extracted by the above conditions E1 to E3 is referred to as relation data.

The data acquisition unit 12 outputs the relation data containing a plurality of phrases acquired in the above manner to the phrase feature value determination unit 13. Further, the data acquisition unit 12 outputs the sentence set used as a basis when acquiring phrases to the set feature value determination unit 14.

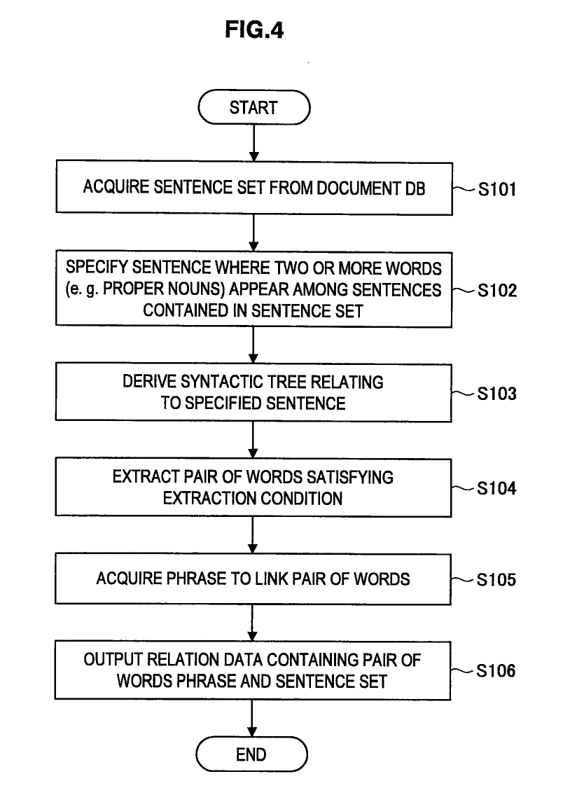

A flow of a data acquisition process by the data acquisition unit 12 is described hereinafter with reference to FIG. 4. FIG. 4 is an illustration to illustrate a flow of a data acquisition process by the data acquisition unit 12.

Referring to FIG. 4, the data acquisition unit 12 first acquires a sentence set from the document DB 11 (S101). Next, the data acquisition unit 12 specifies sentences where two or more words (e.g. proper nouns) appear among the sentences contained in the acquired sentence set (S102). Then, the data acquisition unit 12 analyzes the syntax of the specified sentence and thereby derives a syntactic tree of each sentence (S103). The data acquisition unit 12 then extracts a pair of words that satisfy a prescribed extraction condition (e.g. the conditions E1 to E3) from the sentences specified in the step S202 (S104).

Then, the data acquisition unit 12 acquires a phrase to link the pair of words extracted in the step S204 from each corresponding sentence (S105). The data acquisition unit 12 then outputs relation data that contains a plurality of relations respectively corresponding to groups of a pair of words and a corresponding phrase to the phrase feature value determination unit 13. Further, the data acquisition unit 12 outputs the sentence set used as a basis of acquiring the phrases to the set feature value determination unit 14 (S106).

### (Phrase Feature Value Determination Unit 13)

The phrase feature value determination unit 13 determines a phrase feature value that represents a feature of each phrase acquired by the data acquisition unit 12. Note that the phrase feature value referred to herein is a vector quantity in a vector space having components that respectively correspond to words which appear one or more times in a plurality of phrases. For example, when 300 kinds of words appear in 100 phrases, the dimension of the phrase feature value can be 300 dimensions.

The phrase feature value determination unit 13 determines a vector space of phrase feature values based on a vocabulary of words that appear in a plurality of phrases and then determines a phrase feature value for each phrase according to the presence or absence of appearance of each word in each phrase. For example, the phrase feature value determination unit 13 sets a component corresponding to a word that appears in each phrase to “1” and a component corresponding to a word that does not appear in each phrase to “0” as the phrase feature value of each phrase.

Note that when determining the vector space of phrase feature values, it is preferred to treat words that make no sense when representing the feature of a phrase (for example, articles, reference terms, relative pronouns and the like) as stop words and exclude words equivalent to the stop words from components. Further, the phrase feature value determination unit 13 may evaluate the TF/IF (Term Frequency/Inverse Document Frequency) score of words that appear in a phrase, for example, and exclude the words with a low score (with a low importance) from components of the vector space.

Further, the vector space of phrase feature values may have not only words that appear in a plurality of phrases but also components corresponding to word bigrams, word trigrams or the like that appear in the plurality of phrases. Furthermore, other parameters such as the type of parts of speech or the attribute of a word may be contained in the phrase feature value.

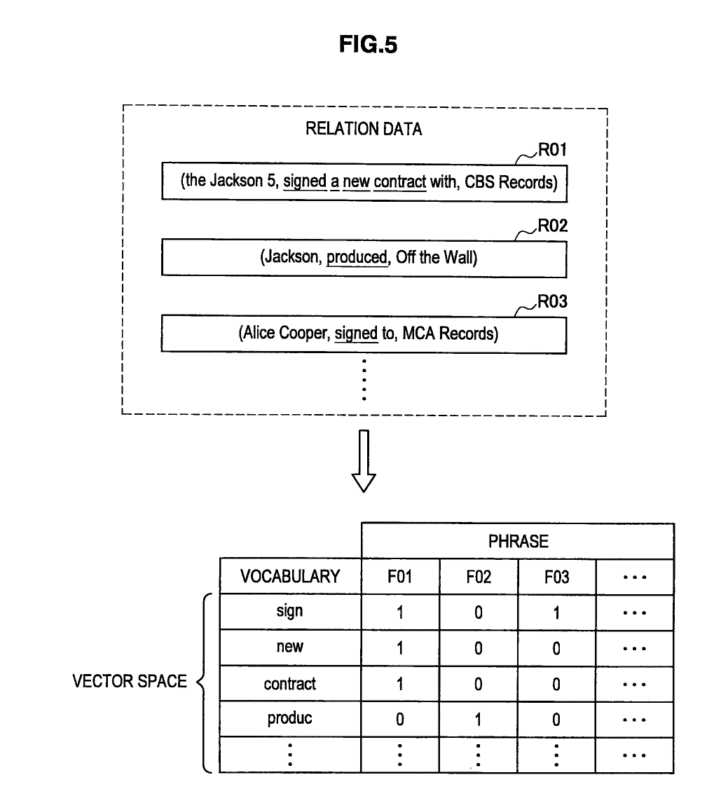

FIG. 5 is an illustration to illustrate a method of determining a phrase feature value by the phrase feature value determination unit 13.

The upper part of FIG. 5 shows an example of relation data that is input from the data acquisition unit 12. In this example, the relation data contains three relations R01, R02 and R03.

For example, the phrase feature value determination unit 13 extracts six words, “signed”, “a”, “new”, “contract”, “produc” and “signed”, from phrases contained in the relation data. Next, the phrase feature value determination unit 13 performs stemming (processing to interpret stems) for the six words and then excludes stop words or the like. As a result of this processing, unique four words (stems), “sign”, “new”, “contract” and “produc”, are specified. Then, the phrase feature value determination unit 13 forms the vector space of phrase feature values which has “sign”, “new”, “contract” and “produc” as components.

On the other hand, the lower part of FIG. 5 shows an example of phrase feature values in the vector space having “sign”, “new”, “contract” and “produc” as components.

The phrase F01 is a phrase corresponding to the relation R01. The phrase feature value of the phrase F01 is: (“sign”,“new”,“contract”,“produc”, . . . )=(1,1,1,0, . . . ).

The phrase F02 is a phrase corresponding to the relation R02. The phrase feature value of the phrase F02 is: (“sign”,“new”,“contract”,“produc”, . . . )=(0,0,0,1, . . . ).

The phrase F03 is a phrase corresponding to the relation R03. The phrase feature value of the phrase F03 is: (“sign”,“new”,“contract”,“produc”, . . . )=(1,0,0,0, . . . ).

In practice, the phrase feature value has a larger number of components, and it is a super-sparse vector in which only a small minority of components have a value different from zero. A matrix in which these phrase feature values are arranged in columns (or rows) forms a phrase feature value matrix.

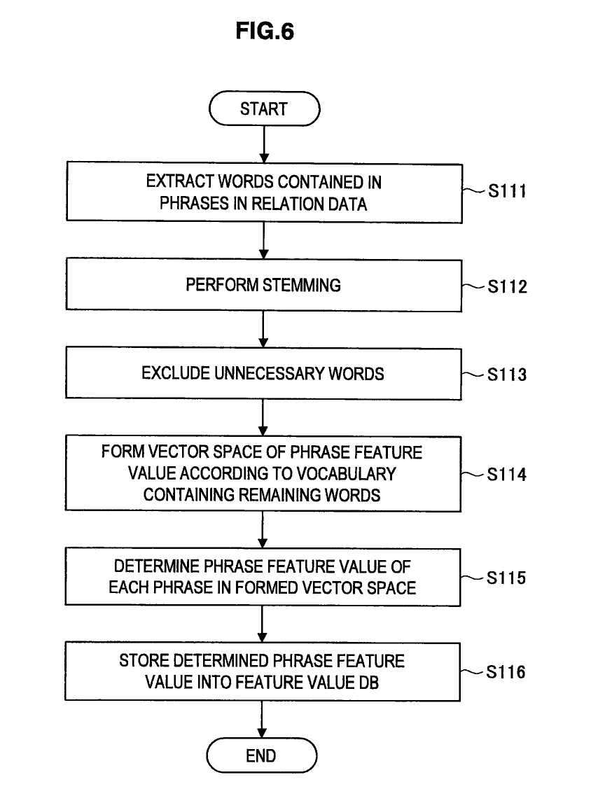

FIG. 6 is an illustration to illustrate a flow of a phrase feature value determination process by the phrase feature value determination unit 13.

Referring to FIG. 6, the phrase feature value determination unit 13 first extracts words contained in phrases in the relation data that is input from the data acquisition unit 12 (S111). Next, the phrase feature value determination unit 13 performs stemming for the extracted words and eliminates a difference in word due to declension (S112). Then, the phrase feature value determination unit 13 excludes unnecessary words such as stop words and words with a low TF/IDF score from the words after stemming (S113). The phrase feature value determination unit 13 then forms a vector space of phrase feature values according to the vocabulary that contains the remaining words (S114).

Then, the phrase feature value determination unit 13 determines a phrase feature value of each phrase according to the presence or absence of appearance of words in each phrase, for example, in the formed vector space (S115). After that, the phrase feature value determination unit 13 stores the determined phrase feature value of each phrase into the feature value DB 15 (S116).

### (Set Feature Value Determination Unit 14)

The set feature value determination unit 14 determines a set feature value that represents the feature of the sentence set that is input from the data acquisition unit 12. The set feature value referred to herein is a matrix having components corresponding to each combination of words that appear in the sentence set. Further, at least a part of the vector space of phrase feature values overlaps with a part of the vector space of a row vector or a column vector that constitutes the set feature value.

The set feature value determination unit 14 may determine the set feature value according to the number of co-occurrences in the sentence set for each combination of words, for example. In this case, the set feature value is a co-occurrence matrix that represents the number of co-occurrences of each combination of words. Further, the set feature value determination unit 14 may determine the set feature value according to a quasi-synonym relationship between words, for example. Furthermore, the set feature value determination unit 14 may determine the set feature value that reflects both the number of co-occurrences of each combination of words and a numerical value corresponding to the quasi-synonymous relationship.

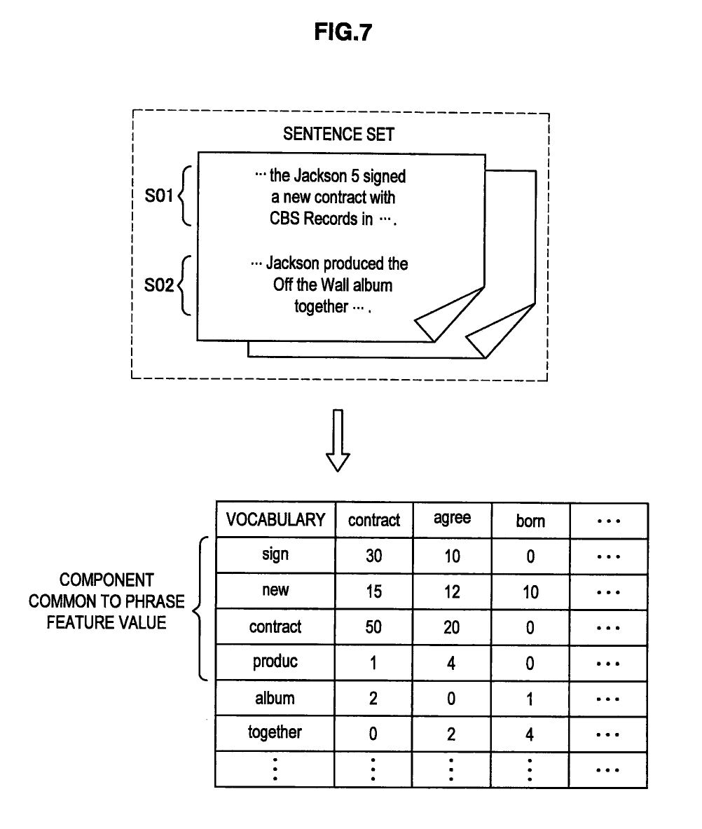

FIG. 7 is an illustration to illustrate a method of determining a set feature value by the set feature value determination unit 14.

The upper part of FIG. 7 shows an example of the sentence set that is input from the data acquisition unit 12.

The sentence set has two sentences S01 and S02 and a plurality of other sentences. The set feature value determination unit 14 extracts words contained in the plurality of sentences of the sentence set, for example. Next, the set feature value determination unit 14 performs stemming for the extracted words and then excludes stop words or the like, and determines a vocabulary to form the feature value space of the set feature value. The vocabulary determined herein includes the words that appear in phrases such as “sign”, “new”, “contract” and “produc” which are components of the vector space of phrase feature values, and, in addition, words that appear in a part different from phrases such as “album” and “together”.

On the other hand, the lower part of FIG. 7 shows the set feature value as a co-occurrence matrix in which the vocabulary of words that appear in the sentence set are allocated as components of both rows and columns.

For example, a value of a component of the set feature value which corresponds to the combination of “sign” and “contract” is “30”. This value indicates that the number of times (the number of sentences) when the combination of “sign” and “contract” appears together in one sentence in the sentence set is 30. Likewise, a value of a component which corresponds to the combination of “sign” and “agree” is “10”. Further, a value of a component which corresponds to the combination of “sign” and “born” is “0”. These values indicate that the number of co-occurrences of each combination of words in the sentence set is 10 and 0, respectively.

Note that, when the set feature value determination unit 14 determines the set feature value according to a quasi-synonymous relationship between word, for example, the set feature value determination unit 14 may determine the component corresponding to a combination of words in a quasi-synonym relationship (including a synonym relationship) in a quasi-synonym dictionary prepared in advance as “1” and determine the other component as “0”. Further, the set feature value determination unit 14 may make a weighted addition of the number of co-occurrences of each combination of words and the value given according to the quasi-synonym dictionary using a given factor.

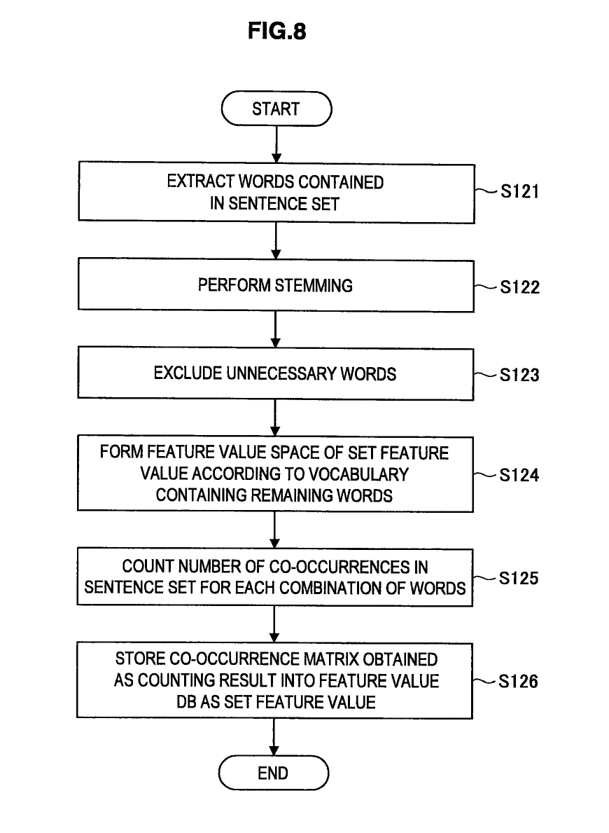

FIG. 8 is an illustration to illustrate a flow (first example) of a set feature value determination process by the set feature value determination unit 14.

As shown in FIG. 8, the set feature value determination unit 14 first extracts words contained in the sentence set that is input from the data acquisition unit 12 (S121). Next, the set feature value determination unit 14 performs stemming for the extracted words and eliminates a difference in word due to declension (S122). Then, the set feature value determination unit 14 excludes unnecessary words such as stop words and words with a low TF/IDF score from the words after stemming (S123).

The set feature value determination unit 14 then forms a feature value space (matrix space) of set feature values according to the vocabulary that contains the remaining words (S124). Then, the set feature value determination unit 14 counts the number of co-occurrences in the sentence set with respect to each combination of words corresponding to each component of the formed feature value space (S125). After that, the set feature value determination unit 14 stores a co-occurrence matrix as a counting result into the feature value DB 15 as the set feature value (S126).

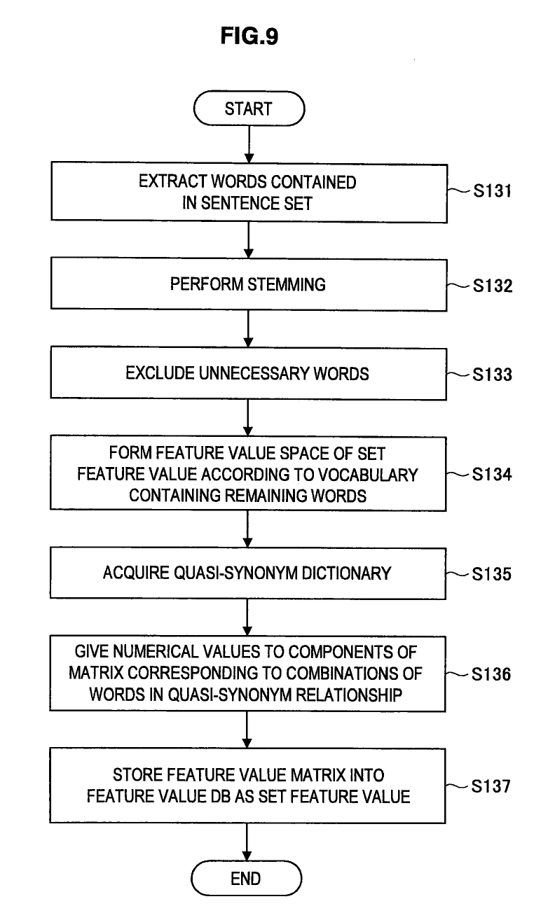

FIG. 9 is an illustration to illustrate a flow (second example) of a set feature value determination process by the set feature value determination unit 14.

As shown in FIG. 9, the set feature value determination unit 14 first extracts words contained in the sentence set that is input from the data acquisition unit 12 (S131). Next, the set feature value determination unit 14 performs stemming for the extracted words and eliminates a difference in word due to declension (S132). Then, the set feature value determination unit 14 excludes unnecessary words such as stop words and words with a low TF/IDF score from the words after stemming (S133).

The set feature value determination unit 14 then forms a feature value space (matrix space) of set feature values according to the vocabulary that contains the remaining words (S134). After that, the set feature value determination unit 14 acquires a quasi-synonym dictionary (S135). Then, the set feature value determination unit 14 gives numerical values to the components of the matrix corresponding to each combination of words having a quasi-synonym relationship in the acquired quasi-synonym dictionary (S136). Finally, the set feature value determination unit 14 stores a feature value matrix in which numerical values are given to the components into the feature value DB 15 as the set feature value (S137).

### (Feature Value DB 15)

The feature value DB 15 stores the phrase feature value determined by the phrase feature value determination unit 13 and the set feature value determined by the set feature value determination unit 14 by using a stored medium. Then, in response to a request from the compression unit 16, the feature value DB 15 outputs the stored phrase feature value and the set feature value to the compression unit 16.

### (Compression Unit 16)

The compression unit 16 generates a compressed phrase feature value with a lower dimension than the above-described phrase feature value and indicating the feature of each phrase acquired by the data acquisition unit 12 by using the phrase feature value and the set feature value input from the feature value DB 15.

As described earlier, the phrase feature value determined by the phrase feature value determination unit 13 is a super-sparse vector value. Therefore, when a vector compression technique based on a general probabilistic technique is applied to such a phrase feature value, the significance of data is lost by the compression. Hence, the compression unit 16 treats the set feature value in addition to the phrase feature value as observational data to make up for the scarcity of information of the feature value and compresses the phrase feature value using the probabilistic technique. The compressed data can be thereby trained effectively based not only on the statistical feature of single phrases but also on the statistical feature of a sentence set to which a phrase belongs.

The probabilistic model used by the compression unit 16 is a probabilistic model that is built using the phrase feature values and the set feature values for a plurality of phrases as observational data, so that a latent variable contributes to the occurrence of the observational data. Further, in the probabilistic model used by the compression unit 16, a latent variable that contributes to the occurrence of the set feature value and a latent variable that contributes to the occurrence of the phrase feature values related to a plurality of phrases are variables that are at least partly common. The probabilistic model is represented by the following equation (1), for example.

$$p ( X , F \vert U , V , {α}_{X} , {α}_{F} ) = {\prod }_{i = 1}^{N} {\prod }_{j = 1}^{M} [ p ( {x}_{ij} \vert {U}_{i} , {V}_{j} , {α}_{X} ) ] \cdot {\prod }_{j = 1}^{L} {\prod }_{k = 1}^{L} [ p ( {f}_{jk} \vert {V}_{j} , {V}_{k} , {α}_{F} ) ] \qquad Equation ( 1 )$$

In the above equation (1), X(xᵢⱼ) indicates a phrase feature value matrix. F(fᵢₖ) indicates a set feature value (matrix). Uᵢ indicates a latent vector corresponding to the i-th phrase. Vⱼ (or Vₖ) indicates a latent vector corresponding to the j-th (or k-th) word. α_{X} corresponds to accuracy of a phrase feature value and gives a dispersion of a normal distribution in the following equation (2). α_{F} corresponds to accuracy of a set feature value and gives a dispersion of a normal distribution in the following equation (3). N indicates the total number of phrases acquired, M indicates the dimension of a vector space of phrase feature values, and L indicates the order of a set feature value.

It should be noted that two random variables included on the right-hand side of the above equation (1) are defined by the following equations (2) and (3). However, G(x|μ,α) is a normal distribution with an average of μ and an accuracy of α.

p(xᵢⱼ|Uᵢ,Vⱼ,α_{X})=G(xᵢⱼ|Uᵢ^{T}Vⱼ,α_{X}) Equation (2)

P(fᵢₖ|Vⱼ,Vₖ,α_{F})=G(fᵢₖ|Vⱼ^{T}Vₖ,α_{F}) Equation (3)

The compression unit 16 sets a conjugate prior distribution based on the above-described probabilistic model and then estimates N number of latent vectors Uᵢ and L number of latent vectors Vⱼ, which are latent variables, according to a maximum likelihood estimation method such as maximum a posteriori estimation or Bayes estimation. Then, the compression unit 16 outputs the latent vectors Uᵢ (i=1 to N) for each phrase obtained as a result of estimation to the compressed feature value DB 17 as a compressed phrase feature value of each phrase.

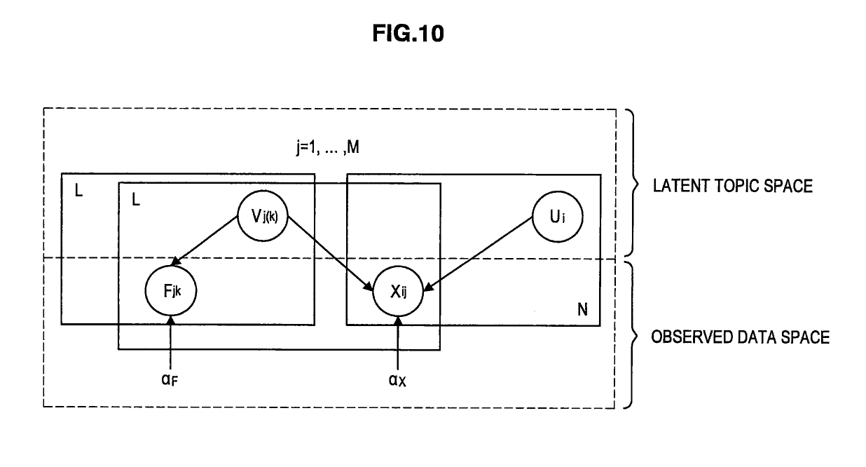

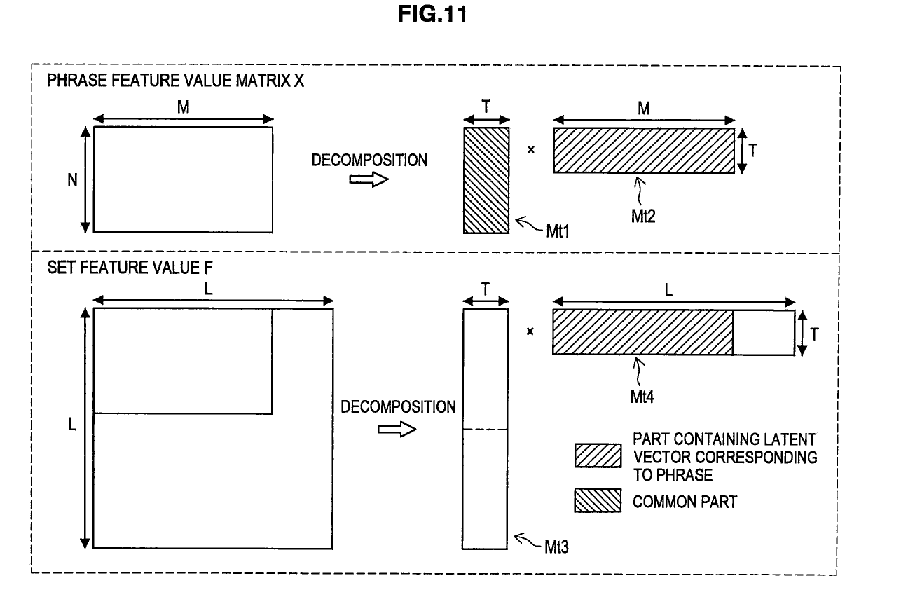

Refer now to FIGS. 10 and 11. FIGS. 10 and 11 are illustrations to conceptually illustrate a method of compressing a phrase feature value.

In FIG. 10, a latent topic space as an example of a data space of latent variables is shown in the upper part, and an observed data space is shown in the lower part.

The latent vector Uᵢ belongs to the latent topic space and contributes to the occurrence of the i-th phrase observed in the sentence set. This means that the semantic aspect of a phrase causes probabilistic effects on the occurrence of a phrase as a language. On the other hand, the latent vector Uᵢ and the latent vector Vⱼ (Vₖ) contribute to the occurrence of the j-th word contained in the i-th phrase. This means that the semantic aspect of a context in the sentence set (or the linguistic tendency of a document etc.) causes probabilistic effects on the occurrence of an individual word, for example.

At this time, the latent vector Vⱼ (Vₖ) contributes not only to the occurrence of the j-th word contained in the i-th phrase but also to the occurrence of a word in another part of the sentence set which is different from the focused phrase. Therefore, by observing the set feature value fᵢₖ in addition to the phrase feature value xᵢⱼ of the i-th phrase, good estimations of the latent vector U, and the latent vector Vⱼ (Vₖ) can be made.

It should be noted that the dimensions of the latent vectors Uᵢ and Vⱼ are equal to the number of topics in the latent topic space. When the number of topics is smaller than the dimension of the phrase feature value, the latent vectors Uᵢ with a lower dimension than the phrase feature value can be obtained as the compressed phrase feature value. The number of topics in the latent topic space may be set to an appropriate number (e.g. 20) according to requirements of processing in the subsequent stage or constraints on resources, for example.

A phrase feature value matrix X with N rows and M columns is shown in the upper part of FIG. 11. Further, a set feature value F with L rows and L columns is shown in the lower part of FIG. 11. It should be noted that, in the phrase feature value matrix X and the set feature value F in FIG. 11, rows and columns are inverted with respect to those of the phrase feature value matrix and the set feature value illustrated in FIGS. 5 and 7, respectively.

When the number of topics in the latent topic space shown in FIG. 10 is T, for example, the phrase feature value matrix X with N rows and M columns shown in FIG. 11 can be decomposed into the product of a low-order matrix Mt1 with N rows and T columns with a lower order and a low-order matrix Mt2 with T rows and M columns with a lower order. The low-order matrix Mt1 is a matrix in which the latent vectors Uᵢ with a dimension T are arranged in rows. Likewise, the set feature value F with L rows and L columns can be decomposed into the product of a low-order matrix Mt3 with L rows and T columns and a low-order matrix Mt4 with T rows and L columns. The low-order matrix Mt3 is a matrix in which the latent vectors Vⱼ with a dimension T are arranged in rows.

Based on the assumption that a latent variable in the shaded area of the low-order matrix Mt2 and a latent variable in the shaded area of the low-order matrix Mt4 have the same value, the compression unit 16 estimates the low-order matrixes Mt1, Mt2, Mt3 and Mt4 with the maximum likelihood that approximately derive the phrase feature value matrix X and the set feature value F. The compression unit 16 can thereby obtain the low-order matrix Mt1 (i.e. the latent vector Uᵢ) which is more significant than that when estimating the low-order matrixes Mt1 and Mt2 from the phrase feature value matrix X only.

In the example of FIG. 11, a structure in which the dimension L of the vector space of set feature values is larger than the dimension M of the vector space of phrase feature values is shown. With L>M, the significance of compression of the phrase feature value can be enhanced based on the tendency of not only words that appear in phrases but also words that do not appear in phrases but appear in a sentence set to which phrases belong. However, the dimensions may be L=M or L<M. In this case also, because the set feature value with L rows and L columns is generally denser (not super-sparse) than the phrase feature value matrix with N rows and M columns, the scarcity of information of the phrase feature value is made up by the set feature value, and its effect can be expected.

### (Compressed Feature Value DB 17)

The compressed feature value DB 17 stores the compressed phrase feature value generated by the compression unit 16 using a storage medium. Then, in response to a request from the clustering unit 18, the compressed feature value DB 17 outputs the stored compressed phrase feature value to the clustering unit 18. Further, the compressed feature value DB 17 stores a result of clustering by the clustering unit 18 in association with the compressed phrase feature value.

### (Clustering Unit 18)

The clustering unit 18 clusters a plurality of compressed phrase feature values generated by the compression unit 16 according to the similarity between the feature values. The clustering by the clustering unit 18 is performed according to a clustering algorithm such as K-means. Further, the clustering unit 18 assigns a label corresponding to a phrase representative of each cluster to each of one or more clusters generated as a result of the clustering.

However, the cluster to which the label is assigned is not all of the clusters generated according to a clustering algorithm but some of the clusters that satisfy the following selection condition, for example.

(Selection Condition) The number of phrases in a cluster (overlapping phrases are counted separately) is in the top N_{f} of all clusters, and the similarity of the compressed phrase feature values for all pairs of phrases in the cluster is equal to or higher than a prescribed threshold.

Note that, as the similarity in the above selection condition, the cosine similarity or the inner product between the compressed phrase feature values may be used, for example.

Further, the phrase representative of the selected cluster may be a phrase that is contained most often in the cluster among unique phrases in the cluster, for example. The clustering unit 18 may calculate the sum of compressed phrase feature values with respect to phrases having the same string, for example, and assign the string of the phrase with the maximum sum as the label of the cluster.

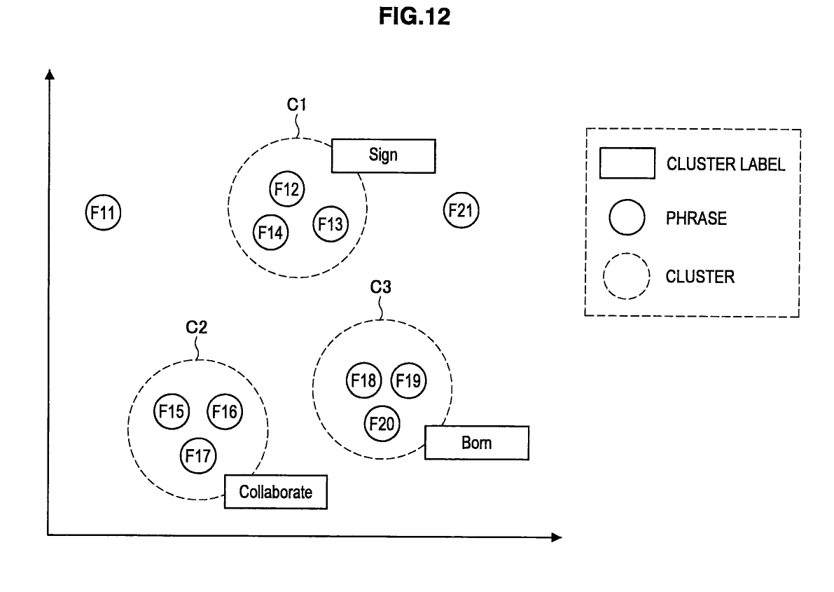

FIG. 12 is an illustration showing a result of clustering of phrases by the clustering unit 18.

FIG. 12 shows an example of a compressed phrase feature value space. In the compressed phrase feature value space, eleven phrases F11 to F21 are located in the positions corresponding to their compressed phrase feature values.

Among the eleven phrases F11 to F21, the phrases F12 to F14 are classified as a cluster C1. Further, the phrases F15 to F17 are classified as a cluster C2. Furthermore, the phrases F18 to F20 are classified as a cluster C3.

Further, the string “Sign” is assigned as a label to the cluster C1. The string “Collaborate” is assigned as a label to the cluster C2. The string “Born” is assigned as a label to the cluster C3. These labels of the clusters are assigned according to a string of a phrase representative of each cluster. The clustering unit 18 stores such a result of clustering in association with the compressed phrase feature value into the compressed feature value DB 17.

Note that, in stead of assigning a label of a cluster according to a phrase representative of each cluster, when a phrase for which a cluster to belong to is known (which is referred to hereinafter as a teacher phrase) is given in advance, the teacher phrase or a string associated with the teacher phrase may be assigned as a label of the cluster.

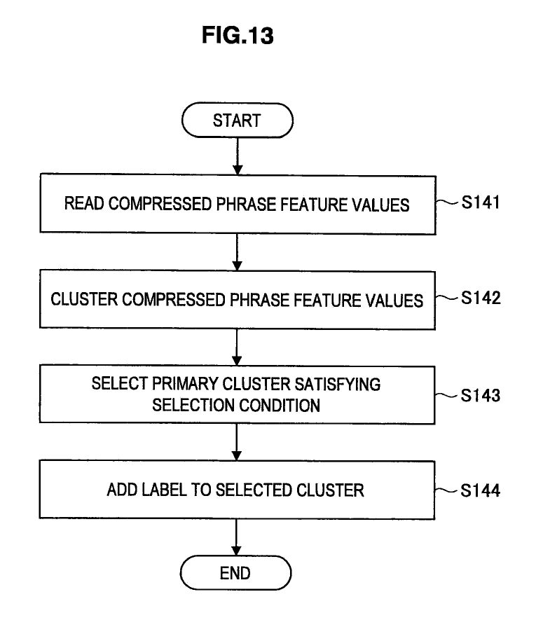

FIG. 13 is an illustration to illustrate a flow of a clustering process by the clustering unit 18.

As shown in FIG. 13, the clustering unit 18 first reads the compressed phrase feature values related to a plurality of phrases contained in a sentence set from the compressed feature value DB 17 (S141). Next, the clustering unit 18 clusters the compressed phrase feature values according to a prescribed clustering algorithm (S142). Then, the clustering unit 18 determines whether each cluster satisfies a prescribed selection condition, and selects primary clusters that satisfy the prescribed selection condition (S143). After that, the clustering unit 18 assigns a label corresponding to a string of a phrase representative of each cluster to each of the selected clusters (S144).

### (Summarizing Unit 19)

The summarizing unit 19 focuses attention on a particular word contained in a sentence set and creates summary information for the focused word by using a result of clustering by the clustering unit 18 for phrases related to the focused word. Specifically, the summarizing unit 19 extracts a plurality of relations related to the focused word from relation data. Then, if a phrase of the first relation and a phrase of the second relation extracted are both classified as one cluster, the summarizing unit 19 adds the other word in the first relation and the other word in the second relation to the contents of the summary for the label assigned to the one cluster.

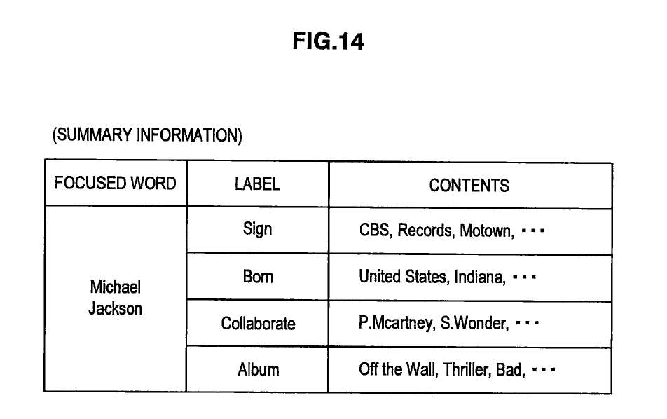

FIG. 14 shows summary information as an example created by the summarizing unit 19. The focused word in the summary information is “Michael Jackson”. Further, the summary information contains four labels: “Sign”, “Born”, “Collaborate” and “Album”.

In this summary information, the contents related to the label “Sign” are “CBS Records” and “Motown”. For example, a phrase is “signed to” for a pair of words “Michael Jackson”, which is the focused word, and “CBS Records”, and a phrase is “contracted with” for a pair of words “Michael Jackson” and “Motown”. When these phrases are classified as the cluster with the label “Sign”, such an entry of the summary information can be created.

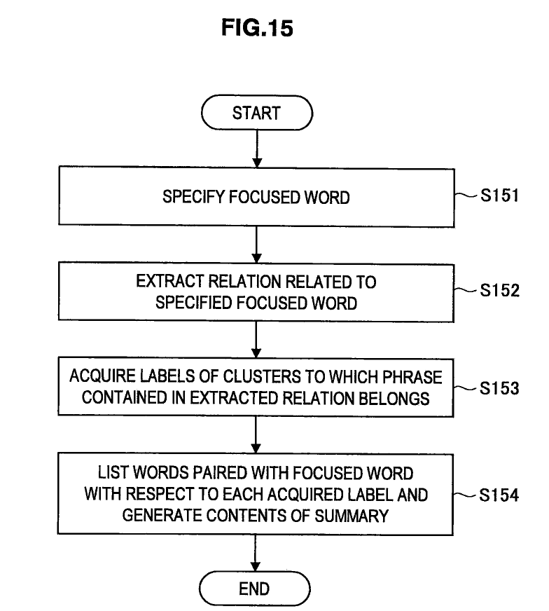

FIG. 15 is an illustration to illustrate a flow of a summary information creation process by the summarizing unit 19.

Referring to FIG. 15, the summarizing unit 19 first specifies a focused word (S151). The focused word may be a word that is indicated by a user, for example. Alternatively, the summarizing unit 19 may automatically specify a word such as one or more proper nouns contained in relation data, for example, as the focused word.

Next, the summarizing unit 19 extracts a relation related to the specified focused word from the relation data (S152). The relation related to the focused word is a relation in which either one of a pair of words is the focused word, for example. Then, the summarizing unit 19 acquires labels of clusters to which a phrase contained in the extracted relation belongs from a result of clustering (S153). The summarizing unit 19 then lists words that are paired with the focused word with respect to each of the acquired labels to thereby generate the contents of summary (S154). The summarizing unit 19 outputs the summary information created in this manner to the summary DB 20.

### (Summary DB 20)

The summary DB 20 stores the summary information created by the summarizing unit 19 by using a storage medium. The summary information stored in the summary DB 20 can be used by internal or external applications of the information processing device 10 with various purposes such as information retrieval, advertisement or recommendation, for example.

The functional configuration of the information processing device 10 is described in the foregoing. As described above, with the use of the information processing device 10, words having some relation to a certain focused word are automatically extracted, and further a label indicating a relation between the extracted words and the focused word is assigned. The use of the information processing device 10 thus makes it possible to automatically generate information indicating a relation between two words. Note that the information is used when representing a relation between a seed entity and a related entity by a sentence in an embodiment described hereinbelow.

### 2: Embodiment

One embodiment of the disclosure is described hereinbelow. This embodiment relates to a method of automatically generating a sentence indicating a relation between a seed entity and a related entity (which is referred to hereinafter as a related information sentence).

### [2-1: Functional Configuration of Information Processing Device 100]

A functional configuration of the information processing device 100 capable of implementing a method of automatically generating a related information sentence according to the embodiment is described firstly with reference to FIG. 16. FIG. 16 is an illustration to illustrate the functional configuration of the information processing device 100 according to the embodiment.

Referring to FIG. 16, the information processing device 100 is mainly composed of an input unit 101, a related information search unit 102, an entity search unit 103, a related information sentence generation unit 104, an output unit 105, and a storage unit 106. Further, a related information DB 1061, an entity DB 1062 and a sentence template DB 1063 are stored in the storage unit 106.

First, information of a seed entity (which is referred to hereinafter as seed entity information) and information of a related entity (hereinafter as related entity information) are input to the input unit 101. Note that the seed entity is a content (hereinafter as a seed content; a content purchased by a user, for example) that is used for selecting a content to be recommended (hereinafter as a recommended content) in a content recommendation system, for example. In this case, the related entity is a content to be recommended to a user. Further, the seed entity information is meta-information (e.g. an artist name, an album name etc.) related to the seed content, for example. The related entity information is meta-information (e.g. an artist name, an album name etc) related to the recommended content.

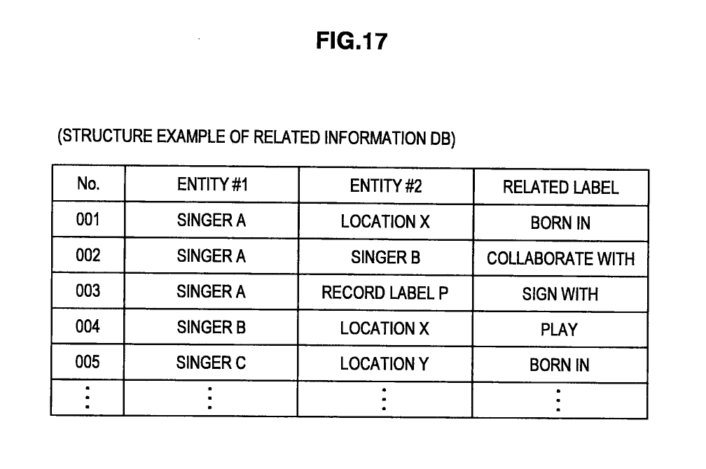

The seed entity information and the related entity information input to the input unit 101 are then input to the related information search unit 102. Upon input of the seed entity information and the related entity information, the related information search unit 102 refers to the related information DB 1061 and searches for a related label related to the seed entity information and the related entity information. The related information DB 1061 is a database that store information indicating a relation between two entities. For example, in the related information DB 1061, related labels indicating a relation between an entity #1 and an entity #2 are stored in association with the entities #1 and #2 as shown in FIG. 17. Note that the relation between the entities #1 and #2 may be automatically extracted from the meta-information of the entities #1 and #2 or the like by the function of the information processing device 10 described earlier.

In the example of FIG. 17, in the related information DB 1061, the information “singer A” of the entity #1, the information “location X” of the entity #2, and the related label “BORN IN” are associated with one another. In this example, the related label “BORN IN” indicates a relation that “the singer A was born in the location X”. Further, in the related information DB 1061 illustrated in FIG. 17, the information “singer A” of the entity #1, the information “singer B” of the entity #2, and the related label “COLLABORATE WITH” are associated with one another. In this example, the related label “COLLABORATE WITH” indicates a relation that “the singer A collaborated with the singer B”. In this manner, the information of the entities #1 and #2 and the related label are stored in association in the related information DB 1061.

The related information search unit 102 first searches for a record that contains both the seed entity information and the related entity information (which is referred to hereinafter as a co-occurrence record) in the related information DB 1061. In the example of FIG. 17, considering the case where the seed entity information is “singer A” and the related entity information is “singer B”, the co-occurrence record is a record No. 002. After detecting the co-occurrence record from the related information DB 1061 in this manner, the related information search unit 102 inputs the seed entity information, the related entity information and the related label which are contained in the detected co-occurrence record to the entity search unit 103.

Next, the related information search unit 102 searches for a record that contains the seed entity information but does not contain the related entity information (which is referred to hereinafter as a seed entity record) in the related information DB 1061. Further, the related information search unit 102 searches for a record that does not contain the seed entity information but contains the related entity information (hereinafter as a related entity record) in the related information DB 1061. Furthermore, the related information search unit 102 searches for a record in which entity information different from the seed entity information contained in the seed entity record and entity information different from the related entity information contained in the related entity record match (hereinafter as a common record).

In the example of FIG. 17, considering the case where the seed entity information is “singer A” and the related entity information is “singer B”, the common record is the records No. 001 and No. 004. In this example, the seed entity record is the records No. 001 and No. 003. On the other hand, the related entity record is the record No. 004. Comparing the records No. 001, No. 003 and No. 004, the records No. 001 and No. 004 both contains the information “location X” of the entity. Therefore, in this example, No. 001 and No. 004 are detected as the common record. After detecting the common record from the related information DB 1061 in this manner, the related information search unit 102 inputs the seed entity information, the related entity information and the related label which are contained in the detected common records to the entity search unit 103.

When any of the co-occurrence record and the common record is not detected, the related information search unit 102 outputs information (NULL) indicating that none of the co-occurrence record and the common record is detected. When NULL is output, the information processing device 100 terminates the generation of a related information sentence.

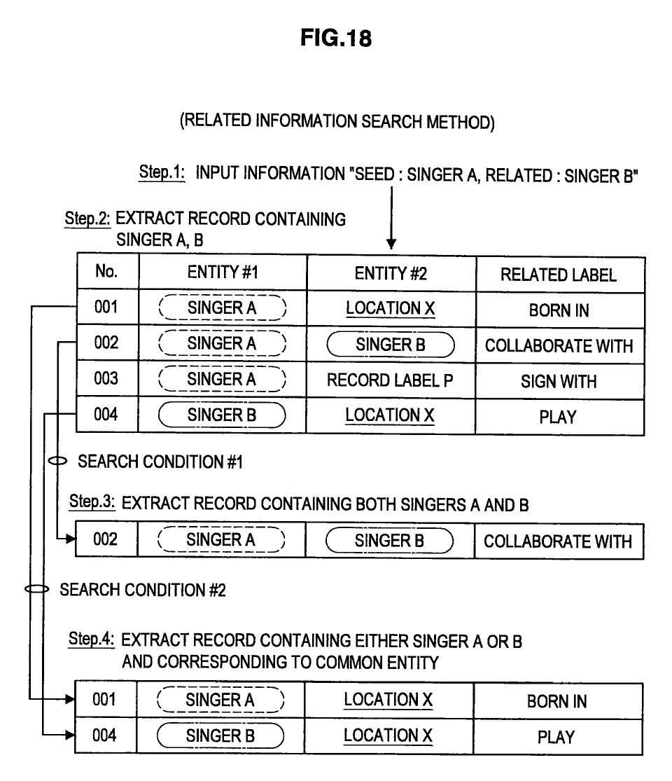

FIG. 18 provides a summary of the search process by the related information search unit 102 described above. A flow of the search process by the related information search unit 102 is described additionally with reference to FIG. 18. Note that, in the example of FIG. 18, the flow of the search process that is executed by the related information search unit 102 when the seed entity information is “singer A” and the related entity information is “singer B” is shown.

First, the seed entity information “singer A” and the related entity information “singer B” are input to the related information search unit 102 from the input unit 101 (Step 1). Next, the related information search unit 102 extracts records that contain “singer A”, “singer B” (Step 2). In this case, the records No. 001 to No. 004 are extracted. Then, the related information search unit 102 searches for a record that meets the following search condition #1 (Step 3). In this case, because the record that contains both “singer A” and “singer B” is the record No. 002, the record No. 002 is extracted as a search result of the search condition #1.

After that, the related information search unit 102 searches for a record that meets the following search condition #2 (Step 4). In this case, the record that contains “singer A” but does not contain “singer B” is the records No. 001 and No. 003. Further, the record that does not contain “singer A” but contains “singer B” is the record No. 004. Among the records No. 001, No. 003 and No. 004, common entity information is “location X”. Then, the record that contains “location X” is the records No. 001 and No. 004. Therefore, the records No. 001 and No. 004 are extracted as a search result of the search condition #2.

### (Search Condition #1: Search Condition for Co-Occurrence Record)

Search for a record that contains both of seed entity information and related entity information

### (Search Condition #2: Search Condition for Common Record)

Search for a record that contains common entity information among records that contain either one of seed entity information and related entity information

Referring back to FIG. 16, after extracting the co-occurrence record and the common record in the above manner, the related information search unit 102 inputs the seed entity information, the related entity information and the related label which are contained in each of the co-occurrence record and the common record to the entity search unit 103. Note that, in the following description, the seed entity information, the related entity information and the related label which are contained in the co-occurrence record and the common record are respectively referred to simply as “co-occurrence record” and “common record” in some cases.

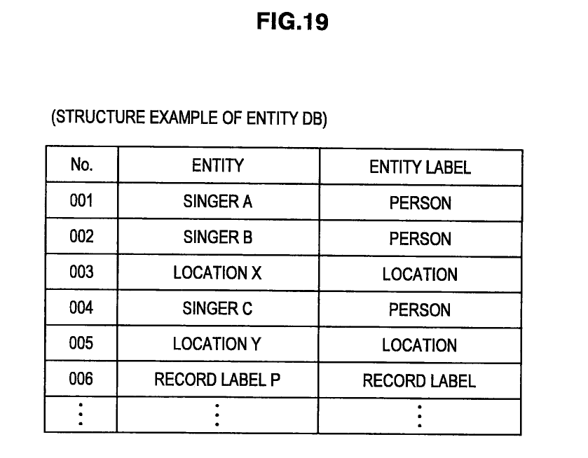

Upon input of the co-occurrence record and the common record, the entity search unit 103 refers to the entity DB 1062 and searches for an entity label that corresponds to information of entities contained in the co-occurrence record and the common record. The entity label is information indicating an attribute of an entity. The entity DB 1062 has a structure as shown in FIG. 19, for example. Referring to FIG. 19, the entity “singer A” is associated with the entity label “PERSON” which indicates that the entity is a “person”. Further, the entity “location X” is associated with the entity label “LOCATION” which indicates that the entity is a “location”.

First, the entity search unit 103 extracts, from the entity DB 1062, the entity label (e.g. “PERSON”) which corresponds to the seed entity information (e.g. “singer A”) contained in the co-occurrence record that is input from the related information search unit 102. Next, the entity search unit 103 extracts, from the entity DB 1062, the entity label (e.g. “PERSON”) which corresponds to the related entity information (e.g. “singer B”) contained in the co-occurrence record that is input from the related information search unit 102.

Then, the entity search unit 103 extracts, from the entity DB 1062, an entity label (e.g. “LOCATION”) that corresponds to entity information (e.g. “location X”) which is different from the seed entity information and the related entity information contained in the common record that is input from the related information search unit 102. After that, the entity search unit 103 assigns the entity label to the information of each entity contained in the co-occurrence record and the common record and inputs the co-occurrence record and the common record to the related information sentence generation unit 104.

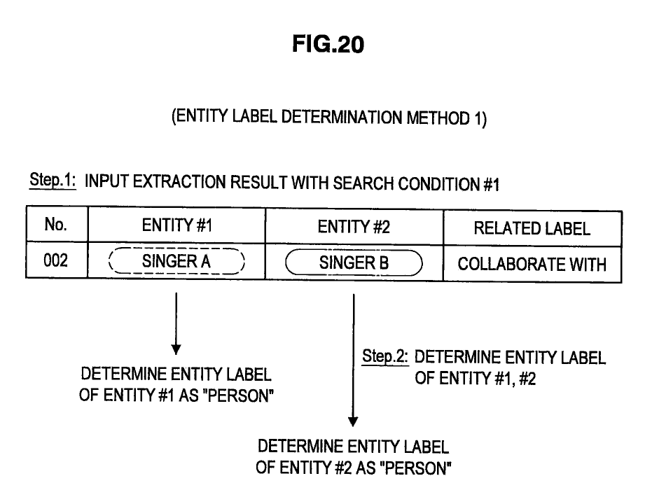

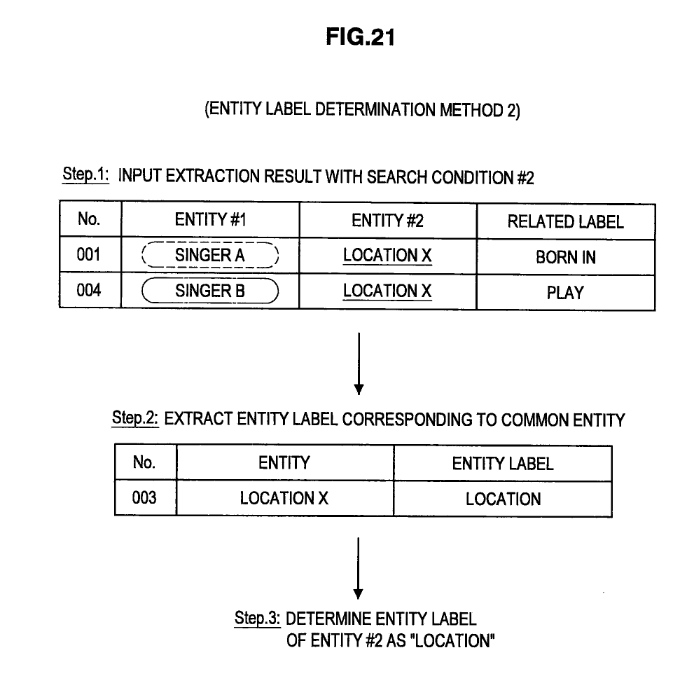

FIGS. 20 and 21 provide a summary of a method of determining an entity label by the entity search unit 103 described above. Referring to FIG. 20, when the extraction result (co-occurrence record) with the search condition #1 is input to the entity search unit 103 (Step 1), an entity label that corresponds to entity information contained in the co-occurrence record is determined (Step 2). At this time, the entity search unit 103 refers to the entity DB 1062 and extracts the entity label corresponding to each of the seed entity information and the related entity information. Then, the entity label extracted by the entity search unit 103 is assigned to the seed entity information and the related entity information contained in the co-occurrence record.

Referring further to FIG. 21, when the extraction result (common record) with the search condition #2 is input to the entity search unit 103 (Step 1), an entity label that corresponds to entity information which is different from the seed entity information and the related entity information contained in the common record is extracted from the entity DB 1062 (Step 2). Then, the entity label extracted from the entity DB 1062 is assigned to the entity information different from the seed entity information and the related entity information contained in the common record (Step 3). In this manner, the entity label is assigned to information of each entity contained in the co-occurrence record and the common record.

Referring back to FIG. 16, after the entity label is assigned to information of each entity by the entity search unit 103 as described above, the information of each entity contained in the co-occurrence record and the common record is input to the related information sentence generation unit 104. Upon input of the information of each entity contained in the co-occurrence record and the common record, the related information sentence generation unit 104 refers to the sentence template DB 1063 and determines a sentence template for generating a related information sentence based on the input information of each entity. Then, the related information sentence generation unit 104 allocates the information of each entity to the determined sentence template and thereby generates a related information sentence.

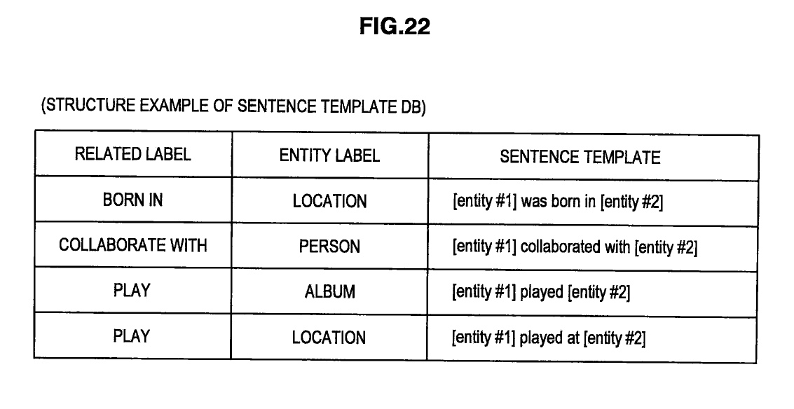

The sentence template DB 1063 has a structure as shown in FIG. 22, for example. Referring to FIG. 22, the sentence template DB 1063 is a database that associates a related label, an entity label and a sentence template with one another. For example, the sentence template “[entity#1] was born in[entity#2]” is associated with the related label “BORN IN” and the entity label “LOCATION”. Note that, however, information of the entities #1 and #2 are respectively allocated to[entity#1] and[entity#2] in the sentence template.

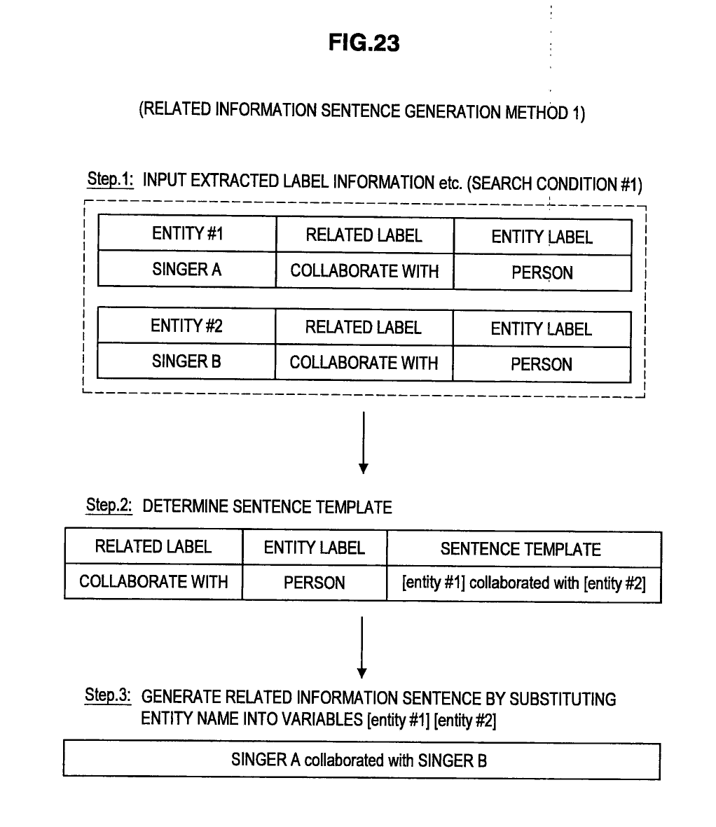

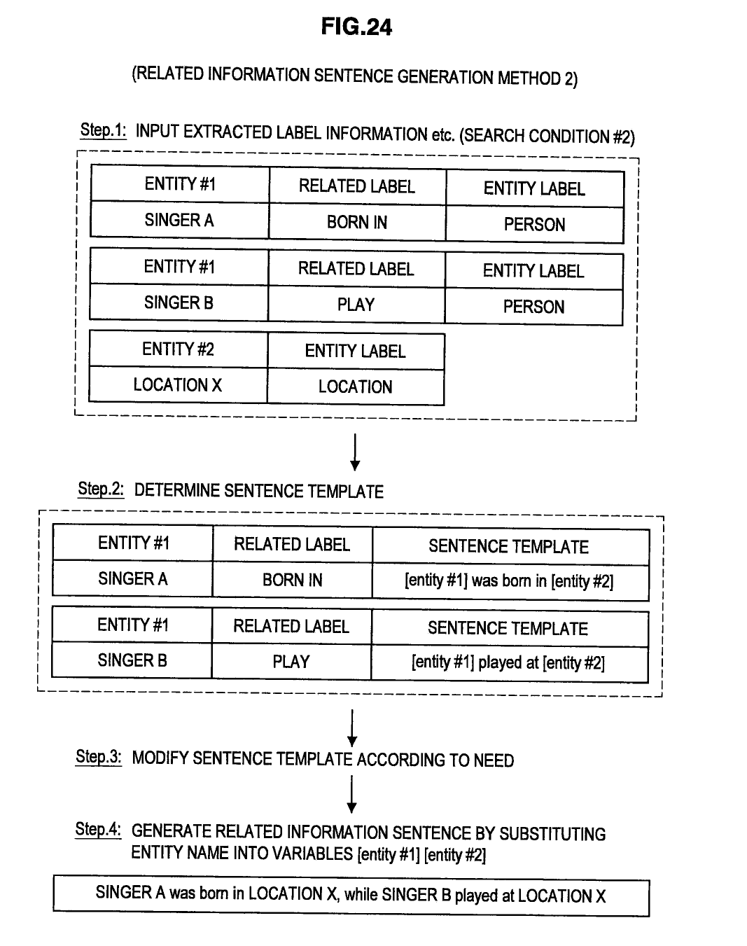

A method of generating a related information sentence by the related information sentence generation unit 104 is described in further detail hereinafter with reference to FIGS. 23 and 24. FIG. 23 is an illustration showing a method of generating a related information sentence by the related information sentence generation unit 104 in the case where the co-occurrence record is input. On the other hand, FIG. 24 is an illustration showing a method of generating a related information sentence by the related information sentence generation unit 104 in the case where the common record is input.

Referring first to FIG. 23, the related label contained in the co-occurrence record and information of the entity label assigned to the seed entity information and the related entity information (which are referred to hereinafter as label information) are input to the related information sentence generation unit 104 (Step 1). In the example of FIG. 23, the seed entity information (corresponding to the entity #1) “singer A”, the related label “COLLABORATE WITH” and the entity label “PERSON” are input to the related information sentence generation unit 104 as the label information. Further, the related entity information (corresponding to the entity #2) “singer B”, the related label “COLLABORATE WITH” and the entity label “PERSON” are input to the related information sentence generation unit 104 as the label information.

The related information sentence generation unit 104 refers to the sentence template DB 1063 (cf. FIG. 22) and extracts the sentence template “[entity#1] was born in[entity#2]” which corresponds to the related label “COLLABORATE WITH” and the entity label “PERSON” from the input label information (Step 2). Then, the related information sentence generation unit 104 allocates the information of each entity “singer A” and “singer B” to variables[entity#1] and[entity#2] that are contained in the extracted sentence template and thereby generates a related information sentence “singer A collaborated with singer B” (Step 3).

Referring next to FIG. 24, the related label contained in the common record and information of the entity label assigned to the seed entity information and the related entity information (label information) are input to the related information sentence generation unit 104 (Step 1).

In the example of FIG. 24, the seed entity information (corresponding to the entity #1) “singer A”, the related label “BORN IN” and the entity label “PERSON” are input to the related information sentence generation unit 104 as the label information. Further, the related entity information (corresponding to the entity #1) “singer B”, the related label “PLAY” and the entity label “PERSON” are input to the related information sentence generation unit 104 as the label information. Further, entity information (corresponding to the entity #2) “location X” which is different from the seed entity information and the related entity information and the entity label “LOCATION” are input to the related information sentence generation unit 104 as the label information.

The related information sentence generation unit 104 refers to the sentence template DB 1063 (cf. FIG. 22) and extracts the sentence template from the input related label of the entity #1 and the entity label of the entity #2 (Step 2). For example, when the related label “BORN IN” of the entity #1 “singer A” and the entity label “LOCATION” of the entity #2 are input, the sentence template “[entity#1] was born in[entity#2]” is extracted. Further, when the related label “PLAY” of the entity #1 “singer B” and the entity label “LOCATION” of the entity #2 are input, the sentence template “[entity#1] played at[entity#2]” is extracted.

After determining the sentence template of the seed entity information (which is referred to hereinafter as a seed entity sentence template) and the sentence template of the related entity information (hereinafter as a related entity sentence template), the related information sentence generation unit 104 modifies the sentence template according to need (Step 3). For example, when the seed entity sentence template and the related entity sentence template are different as shown in FIG. 24, the related information sentence generation unit 104 adds “, while” to the seed entity sentence template and then adds the related entity sentence template after that. On the other hand, when the seed entity sentence template and the related entity sentence template are the same, the related information sentence generation unit 104 adds a part of the seed entity sentence template excluding[entity#1] to “Both seed entity information and related entity information”. At this time, the related information sentence generation unit 104 changes the “to be” verb into a plural form as appropriate.

Then, the related information sentence generation unit 104 allocates the entity information of the entity #2 to the variable[entity #2] contained in the modified sentence template and thereby generates a related information sentence (Step 3). In the example of FIG. 24, the related information sentence “singer A was born in location X, while singer B played at location X” is generated. In this manner, the related information sentence is generated by the related information sentence generation unit 104.

Referring again to FIG. 16, after generating the related information sentence as described above, the related information sentence generation unit 104 inputs the generated related information sentence to the output unit 105. Upon input of the related information sentence, the output unit 105 outputs the input related information sentence. At this time, the output unit 105 may display the related information sentence on a display means (not shown) such as a display or output the related information sentence as sound by using an audio output means (not shown) such as a speaker.

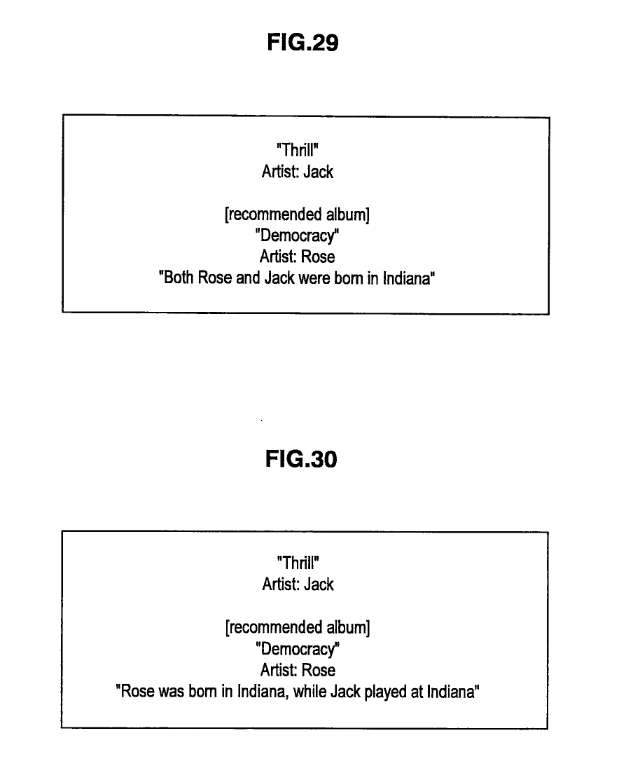

For example, as shown in FIGS. 20 and 30, the output unit 105 displays the related information sentence “Both Rose and Jack were born in Indiana” (cf. FIG. 29), “Rose was born in Indiana, while Jack played at Indiana” (cf. FIG. 30), together with the seed entity information “Jack” and the related entity information “Rose”, on a display means.

The functional configuration of the information processing device 100 is described above. Note that the functional configuration of the information processing device 10, which is described earlier, may be incorporated into the functional configuration of the information processing device 100. In this case, the contents of the related information DB 1061 (cf. FIG. 17) is built from the summary information (cf. FIG. 14) that is generated by the summarizing unit 19 of the information processing device 10. As is easily understood by referring to FIGS. 14 and 17, the related information DB 1061 can be built by altering the structure of the summary DB 20. Note that, however, “label” shown in FIG. 14 corresponds to “related label” shown in FIG. 17. Further, the storage unit 106 of the information processing device 100 may be placed outside the information processing device 100.

### [2-2: Operation of Information Processing Device 100]

The operation of the information processing device 100 is described hereinafter with reference to FIGS. 25 to 28. FIGS. 25 to 28 are illustrations to illustrate the operations of the elements that constitute the information processing device 100. Note that, in this example, a seed artist name is input as the seed entity information, and a related artist name is input as the related entity information.

### (Operation of Related Information Search Unit 102)

The operation of the related information search unit 102 is described firstly with reference to FIG. 25. FIG. 25 is an illustration to illustrate a flow of the process executed by the related information search unit 102.

Referring to FIG. 25, the related information search unit 102 searches for information that contains the seed artist name or the related artist name input from the input unit 101 in the related information DB 1061 (S201). Next, the related information search unit 102 outputs a search result that contains the seed artist name and the related artist name as a search result of the above (search condition #1) to the entity search unit 103 (S202). Then, the related information search unit 102 extracts a record that contains a common entity between a record containing the seed artist name and a record containing the related artist name and outputs the extracted record as a search result of the above (search condition #2) to the entity search unit 103 (S203).

### (Operation of Entity Search Unit 103)

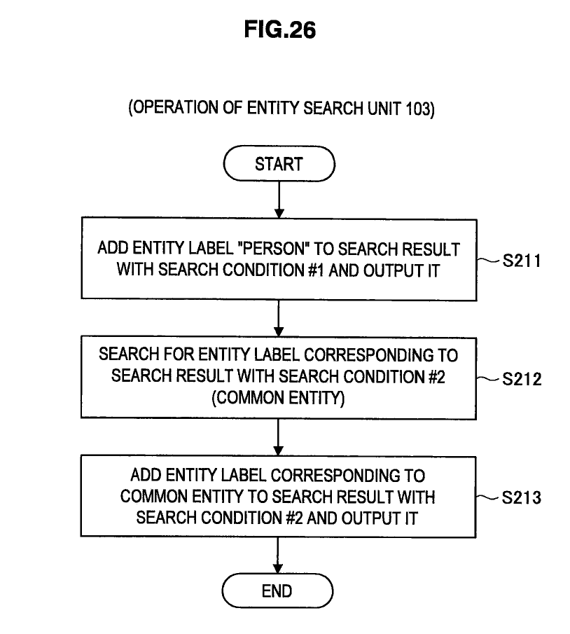

The operation of the entity search unit 103 is described hereinafter with reference to FIG. 26. FIG. 26 is an illustration to illustrate a flow of the process executed by the entity search unit 103.

Referring to FIG. 26, the entity search unit 103 assigns the entity label “PERSON” to the search result (co-occurrence record) of the above (search condition #1) and outputs it to the related information sentence generation unit 104 (S211). Next, the entity search unit 103 searches for an entity label corresponding to the common entity contained in the search result (common record) of the above (search condition #2) in the entity DB 1062 (S212). Then, the entity search unit 103 assigns the entity label extracted from the entity DB 1062 to the common entity and outputs it to the related information sentence generation unit 104 (S213).

### (Operation of Related Information Sentence Generation Unit 104)

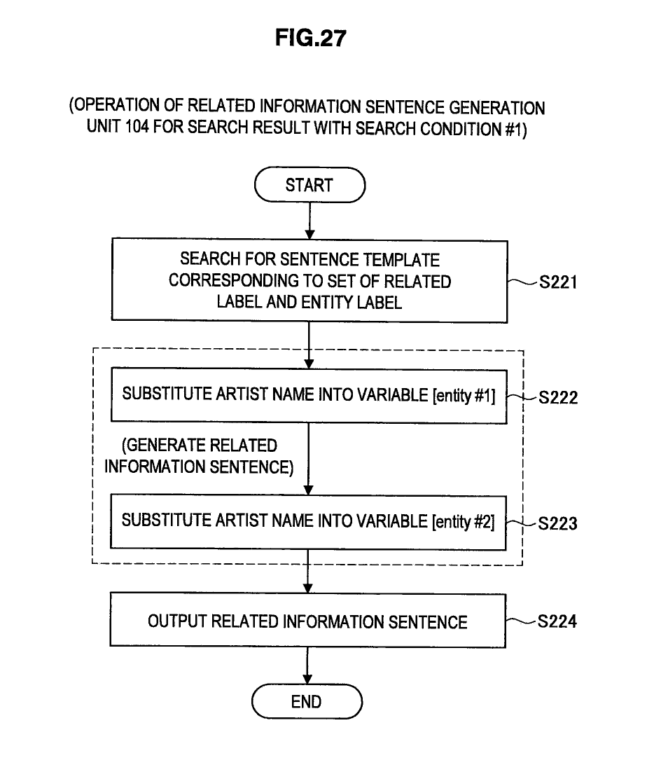

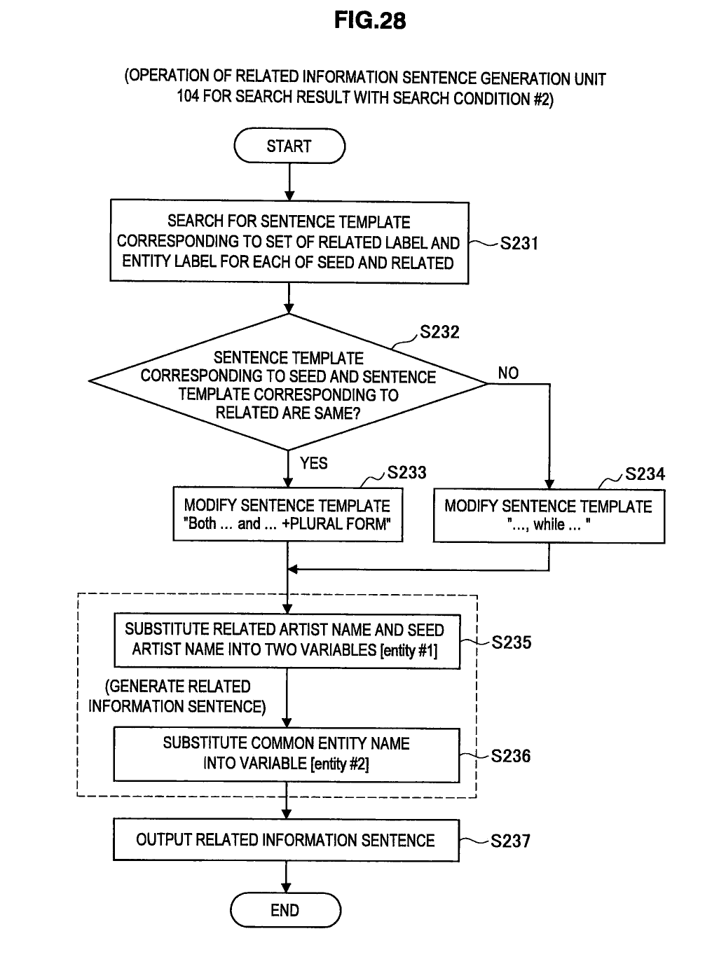

The operation of the related information sentence generation unit 104 is described hereinafter with reference to FIGS. 27 and 28. FIGS. 27 and 28 are illustrations to illustrate a flow of the process executed by the related information sentence generation unit 104. Particularly, FIG. 27 shows the operation of the related information sentence generation unit 104 for a search result with the above (search condition #1). On the other hand, FIG. 28 shows the operation of the related information sentence generation unit 104 for a search result with the above (search condition #2).

Referring first to FIG. 27, the related information sentence generation unit 104 searches for a sentence template that corresponds to a set of the related label and the entity label input from the entity search unit 103 in the sentence template DB 1063 (S221). Next, the related information sentence generation unit 104 substitutes an artist name corresponding to the entity #1 into the variable[entity#1] that is contained in the sentence template extracted from the sentence template DB 1063 (S222). Then, the related information sentence generation unit 104 substitutes an artist name corresponding to the entity #2 into the variable[entity#2] that is contained in the sentence template extracted from the sentence template DB 1063 (S223). After that, the related information sentence generation unit 104 outputs the related information sentence through the output unit 105 (S205).

Referring next to FIG. 28, the related information sentence generation unit 104 searches for a sentence template that corresponds to a set of the related label and the entity label in the sentence template DB 1063 for each of the seed entity information and the related entity information (S231). Next, the related information sentence generation unit 104 determines whether a sentence template (seed entity sentence template) corresponding to the seed entity information and a sentence template (related entity sentence template) corresponding to the related entity information are the same or not (S232). When the seed entity sentence template and the related entity sentence template are the same, the related information sentence generation unit 104 proceeds to Step S233. On the other hand, when the seed entity sentence template and the related entity sentence template are not the same, the related information sentence generation unit 104 proceeds to Step S234.

When the process proceeds to Step S233, the related information sentence generation unit 104 modifies the sentence template into the form “Both . . . and . . . ” and makes the subsequent “to be” verb in a plural form (S233). On the other hand, when the process proceeds to Step S234, the related information sentence generation unit 104 modifies the sentence template into the form “ . . . , while . . . ” (S234). When the processing of the Step S233 or S234 ends, the related information sentence generation unit 104 proceeds to Step S235.

In the step S235, the related information sentence generation unit 104 substitutes the seed artist name and the related artist name into two variables [entity#1] (S235). Then, the related information sentence generation unit 104 substitutes the common entity information into the variable[entity#2] and thereby completes the related information sentence (S236). Then, the related information sentence generation unit 104 outputs the completed related information sentence through the output unit 105 (S237).

The operation of the information processing device 100 is described above. Note that the related information sentence is output in the form as shown in FIGS. 29 and 30.

### 3: Hardware Configuration

The function of each structural element of the information processing device 10 and 100 described above can be realised by using, for example, the hardware configuration of the information processing apparatus shown in FIG. 31. That is, the function of each structural element can be realized by controlling the hardware shown in FIG. 31 using a computer program. Additionally, the mode of this hardware is arbitrary, and may be a personal computer, a mobile information terminal such as a mobile phone, a PHS or a PDA, a game machine, or various types of information appliances. Moreover, the PHS is an abbreviation for Personal Handy-phone System. Also, the PDA is an abbreviation for Personal Digital Assistant.

As shown in FIG. 31, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls entire operation or a part of the operation of each structural element based on various programs recorded on the ROM 904, the RAM 906, the storage unit 920, or a removal recording medium 928. The ROM 904 is means for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removal recording medium 928 such as a magnetic disk, an optical disk, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an electronic device or an IC card on which a non-contact IC chip is mounted. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or a modem for various types of communication. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

### 4: Summary

Finally, a brief summary of the technical matter according to the embodiment of the disclosure is provided below. The technical matter described herein may be applied various kinds of information processing devices such as PCs, mobile phones, portable game machines, portable information terminals, home information appliances and car navigation systems, for example.

The functional configuration of the information processing device described above may be represented as follows. The information processing device includes an information providing unit, a related sentence generation unit and a related sentence providing unit. The information providing unit provides related information related to main information. The related sentence generation unit generates a sentence indicating a relation between the main information and the related information. The related sentence providing unit provides the sentence generated by the related sentence generation unit.

In this manner, at the time of providing the main information and the related information, a sentence indicating a relation between them is provided in addition, thereby attracting interest of a user to receive the information in the related information. This contributes to sales promotion of a product corresponding to the related information and enhancement of the frequency of viewing contents.

### (Remarks)

The output unit 105 described above is an example of the information providing unit and the related sentence providing unit. The seed entity information described above is an example of the main information. The related entity information described above is an example of the related information. The related information sentence generation unit 104 described above is an example of the related sentence generation unit. The related information DB 1061 described above is an example of a first database. The information of the entity #1 described above is an example of first information. The information of the entity #2 described above is an example of second information.

Further, the related label described above is an example of relation information. The sentence template DB 1063 described above is an example of a second database. The co-occurrence record described above is an example of a first record. The common record described above is an example of second and third records. The data acquisition unit 12 described above is an example of a phrase acquisition unit. The summarizing unit 19 described above is an example of a relation information generation unit. The compression unit 16 described above is an example of a compressed phrase feature value generation unit.

The preferred embodiments of the present disclosure have been described above with reference to the accompanying drawings, whilst the present disclosure is not limited to the above examples, of course. It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2010-168336 filed in the Japan Patent Office on Jul. 27, 2010, the entire content of which is hereby incorporated by reference.

What is claimed is:

1. An information processing device comprising:
an information providing unit that provides related information related to main information;
a related sentence generation unit that generates a sentence indicating a relation between the main information and the related information; and
a related sentence providing unit that provides the sentence generated by the related sentence generation unit.

2. The information processing device according to claim 1, further comprising:
a storage unit that stores a first database associating relation information indicating a relation between first information and second information, the first information, and the second information, and a second database associating the relation information and a sentence template,
wherein the related sentence generation unit
extracts a first record where the first or second information matches the main information and the second or first information matches the related information from the first database,
extracts a sentence template corresponding to the relation information contained in the first record from the second database, and
generates a sentence indicating a relation between the main information and the related information by using the first and second information contained in the first record and the sentence template extracted from the second database.

3. The information processing device according to claim 2, wherein
the related sentence generation unit
extracts a second record where the first or second information matches the main information and being different from the first record, and a third record where the first or second information matches the related information and being different from the first record, from the first database,
when the second and third records are extracted, extracts a set of the second and third records where the second or first information contained in the second record and being different from the main information and the second or first information contained in the third record and being different from the related information match,
extracts a sentence template corresponding to the relation information contained in the second or third record forming the set of the second and third records from the second database, and
generates a sentence indicating a relation between the main information and the related information by using the first and second information contained in the second or third record forming the set of the second and third records and the sentence template extracted from the second database.

4. The information processing device according to claim 3, wherein
the main information, the related information and the first and second information are words,
the relation information is information indicating a relation between words, and
the related sentence generation unit generates a sentence by applying a word of the main information and a word of the related information to a sentence template corresponding to the relation information.

5. The information processing device according to claim 4, further comprising:
a phrase acquisition unit that acquires a phrase contained in each sentence from a sentence set including a plurality of sentences;
a phrase feature value determination unit that determines a phrase feature value indicating a feature value of each phrase acquired by the phrase acquisition unit;
a clustering unit that clusters the phrase feature value determined by the phrase feature value determination unit according to a similarity between feature values; and
a relation information generation unit that extracts a relation between words contained in the sentence set using a result of clustering by the clustering unit, and generates relation information indicating a relation between a word of the first information and a word of the second information,
wherein the relation information generation unit stores the word of the first information, the word of the second information, and the relation information between the word of the first information and the word of the second information into the first database.

6. The information processing device according to claim 4, further comprising:
a phrase acquisition unit that acquires a phrase contained in each sentence from a sentence set including a plurality of sentences;
a phrase feature value determination unit that determines a phrase feature value indicating a feature value of each phrase acquired by the phrase acquisition unit;
a set feature value determination unit that determines a set feature value indicating a feature of the sentence set;
a compressed phrase feature value generation unit that generates a compressed phrase feature value with a lower dimension than the phrase feature value based on the phrase feature value determined by the phrase feature value determination unit and the set feature value determined by the set feature value determination unit;
a clustering unit that clusters the compressed phrase feature value generated by the compressed phrase feature value generation unit according to a similarity between feature values; and
a relation information generation unit that extracts a relation between words contained in the sentence set using a result of clustering by the clustering unit, and generates relation information indicating a relation between a word of the first information and a word of the second information,
wherein the relation information generation unit stores the word of the first information, the word of the second information, and the relation information between the word of the first information and the word of the second information into the first database.

7. A related sentence providing method comprising:
providing related information related to main information;
generating a sentence indicating a relation between the main information and the related information; and
providing the sentence.

8. A program causing a computer to implement:
an information providing function that provides related information related to main information;
a related sentence generation function that generates a sentence indicating a relation between the main information and the related information; and
a related sentence providing function that provides the sentence generated by the related sentence generation function.
